(19) United States
(12) Patent Application Publication
(10) Pub. No.: US 2025/0348012 A1
(43) Pub. Date: Nov. 13, 2025

(54) IMAGE FORMING APPARATUS

(71) Applicant: CANON KABUSHIKI KAISHA, Tokyo (JP)

(72) Inventors: SHUMA HIASA, Kanagawa (JP); TOMOYA TATEISHI, Kanagawa (JP)

(21) Appl. No.: 19/196,271

(22) Filed: May 1, 2025

(30) Foreign Application Priority Data
May 7, 2024 (JP) 2024-075333

(51) Int. Cl. G03G 15/01

(52) U.S. Cl. CPC G03G 15/0173

(57) ABSTRACT

An image forming apparatus includes a rotary, a main assembly frame, a first supporting member, and a first moving member. The first supporting member is movable from a first taking-out position to a first accommodating portion in a first movement direction through an opening. The first moving member is positioned in a first position when the first toner cartridge is mounted to the first supporting member and is positioned in a second position when the first toner cartridge is demounted from the first supporting member. In a state in which the first supporting member is in the first taking-out position, as viewed in the first movement direction, a whole of the first moving member in the first position is positioned inside the opening and at least a part of the first moving member in the second position projects to an outside of the opening.

### FIELD OF THE INVENTION AND RELATED ART

The present invention relates to an image forming apparatus for forming an image on a recording material.

In an image forming apparatus of an electrophotographic type, a rotary developing type in which a color image is formed by rotating a rotary provided with a plurality of developing members has been known. In Japanese Laid-Open Patent Applications Nos. 2007-183305, and 2008-096852, an image forming apparatus including a rotary provided with a plurality of developing rollers and a plurality of toner cartridges (toner accommodating containers) each detachably mountable to the rotary.

In the image forming apparatus of the electrophotographic type, a constitution in which a cartridge is mounted to and demounted from an apparatus main assembly by using a tray has been known.

### SUMMARY OF THE INVENTION

A principal object of the present invention is to provide an image forming apparatus capable of suppressing forgetting of mounting of a cartridge to a tray.

According to an aspect of the present invention, there is provided an image forming apparatus to which a first toner cartridge is detachably mounted, comprising: a rotatable rotary including a first developing roller and a first accommodating frame including a first accommodating portion for accommodating toner supplied to the first developing roller; a main assembly frame provided with an opening and configured to accommodate the rotary; a first supporting member configured to support the first toner cartridge and movable from a first taking-out position to a first accommodating position in a first movement direction through the opening, wherein in a state in which the first supporting member is in the first accommodating position, the first toner cartridge is in a first mounting position relative to the first accommodating frame, where supply of the toner from the first toner cartridge to the first accommodating frame is permitted, and in a state in which the first supporting member is in the first taking-out position, the first toner cartridge is in a first retracted position where the first toner cartridge is detachably mountable to the first supporting member; and a first moving member mounted to the first supporting member, the first moving member being positioned in a first position when the first toner cartridge is mounted to the first supporting member and being positioned in a second position when the first toner cartridge is demounted from the first supporting member, wherein in the state in which the first supporting member is in the first taking-out position, as viewed in the first movement direction, a whole of the first moving member in the first position is positioned inside the opening and at least a part of the first moving member in the second position projects to an outside of the opening.

According to another aspect of the present invention, there is provided an image forming apparatus to which a first toner cartridge is detachably mounted, comprising: a rotatable rotary including a first developing roller and a first accommodating frame including a first accommodating portion for accommodating toner supplied to the first developing roller; a main assembly frame configured to accommodate the rotary; a first supporting member configured to support the first toner cartridge and movable from a first taking-out position to a first accommodating position, wherein in a state in which the first supporting member is in the first accommodating position, the first toner cartridge is in a first mounting position relative to the first accommodating frame, where supply of the toner from the first toner cartridge to the first accommodating frame is permitted, and in a state in which the first supporting member is in the first taking-out position, the first toner cartridge is in a first retracted position where the first toner cartridge is detachably mountable to the first supporting member; and a first moving member mounted to the first supporting member, the first moving member being positioned in a first position when the first toner cartridge is mounted to the first supporting member and being positioned in a second position when the first toner cartridge is demounted from the first supporting member, wherein in when the first moving member is positioned in the first position, movement of the first supporting member from the first taking-out position to the first accommodating position is permitted, and when the first moving member is positioned in the second position, the movement of the first supporting member from the first taking-out position to the first accommodating position is restricted.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to an embodiment 1.

FIG. 2 is a constitution diagram of the image forming apparatus of the embodiment 1.

FIG. 3 is a schematic view of a developing unit, a toner cartridge, and a tray in the embodiment 1.

Parts (a) and (b) of FIG. 4 are sectional views of the image forming apparatus of the embodiment 1.

FIG. 5 is a perspective view of a rotary main body in the embodiment 1.

Parts (a), (b), and (c) of FIG. 6 are perspective views of the image forming apparatus of the embodiment 1.

Parts (a) and (b) of FIG. 7 are sectional views of the image forming apparatus of the embodiment 1.

FIG. 8 is an illustration of the rotary main body in the embodiment 1.

FIG. 9 is an illustration of the rotary main body in the embodiment 1.

FIG. 10 is an illustration of the rotary main body in the embodiment 1.

Parts (a) and (b) of FIG. 11 are illustrations of a constitution relating to the movement of the tray in the embodiment 1.

Parts (a) and (b) of FIG. 12 are illustrations of the constitution relating to the movement of the tray in the embodiment 1.

Parts (a), and (b) of FIG. 13 are perspective views showing a swing arm and the tray in the embodiment 1.

Parts (a) and (b) of FIG. 14 are front views showing an opening of a frame and the swing arm in the embodiment 1.

Parts (a) and (b) of FIG. 15 are sectional views showing an operation of the swing arm in the embodiment 1.

Parts (a) and (b) of FIG. 16 are perspective views showing a swing arm and a tray in an embodiment 2.

Parts (a) and (b) of FIG. 17 are sectional views showing an operation of a swing arm in 2.

Parts (a) and (b) of FIG. 18 are sectional views showing an operation of a swing arm in a modified embodiment of the embodiment 2.

### DESCRIPTION OF THE EMBODIMENTS

In the following, embodiments of the present invention will be described with reference to the drawings.

### Embodiment 1

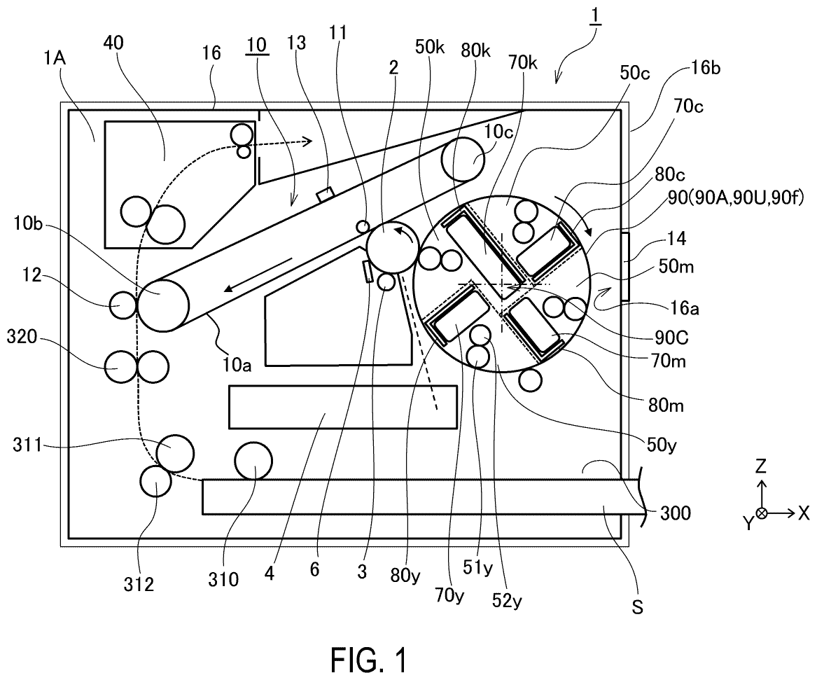

By using FIG. 1 to parts (a) and (b) of FIG. 12, an image forming apparatus 1 according to an embodiment 1 will be described.

In the following description and respective drawings, a vertical direction in the case where the image forming apparatus 1 is installed on a horizontal surface is a Z direction. A direction (rotational axis direction of a rotary) of a rotational axis 90C of a rotary main body 90 described later, which is a direction crossing the Z direction is a Y direction. Incidentally, a direction (rotational axis direction of a photosensitive drum) of a photosensitive drum 2 is parallel to the direction of the rotational axis 90C, and is also the Y direction. A direction crossing both the Z direction and the Y direction is an X direction. The X direction and the Y direction may preferably be a horizontal direction. Further, the X direction, the Y direction, and the Z direction may preferably be perpendicular to each other. Further, as needed, directions of arrows X, Y, and Z indicated in the respective drawings are represented by +X side, +Y side, and +Z side, respectively, and opposite sides therefrom are represented by −X side, −Y side, and −Z side, respectively.

### (General Constitution of Image Forming Apparatus)

First, a general constitution of the image forming apparatus 1 will be described. The image forming apparatus 1 is a laser beam printer for forming an image on a sheet S by an electrophotographic system. Specifically, the image forming apparatus 1 is a color laser beam printer provided with four developing units 50y, 50m, 50c, and 50k. As the sheet S which is a recording material (recording medium), various sheet materials different in size and material, including paper such as plain paper and thick paper; a plastic film; a cloth; a surface-treated sheet material such as coated paper; a special-shaped sheet material such as an envelope and index paper; and the like are usable.

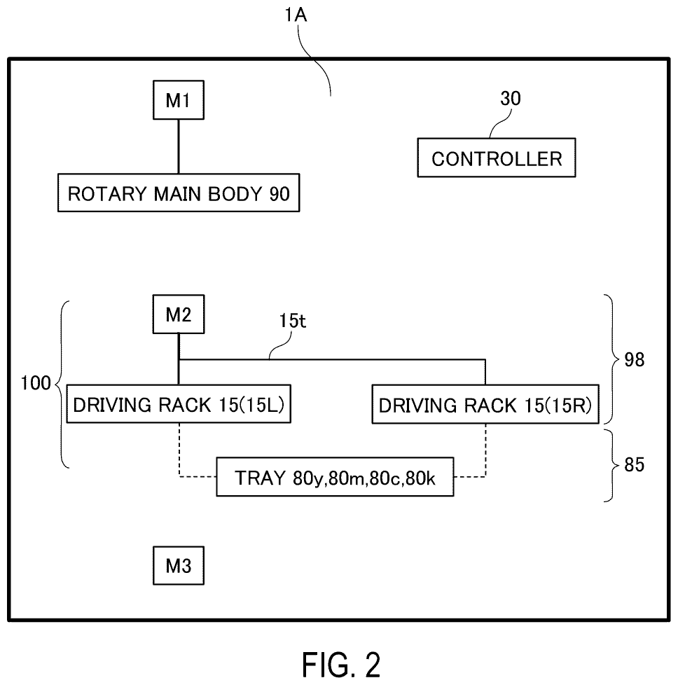

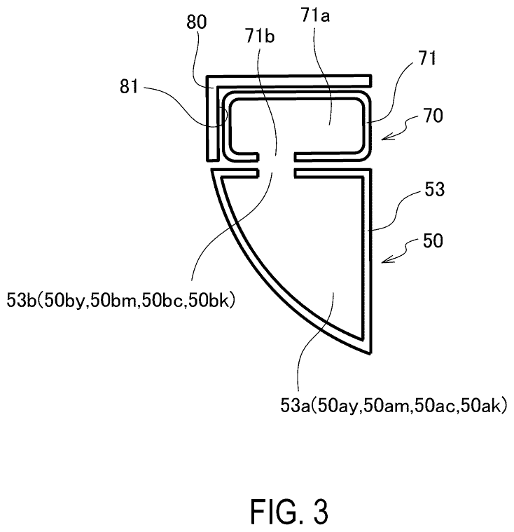

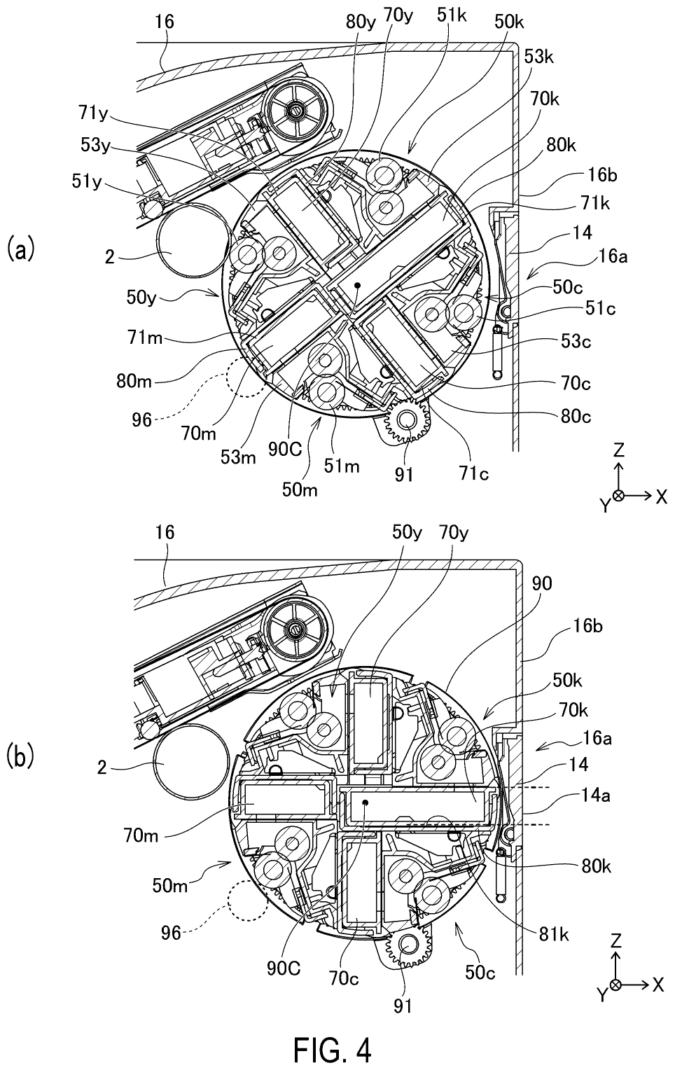

By using FIGS. 1, 2, and 3, a schematic constitution and an image forming operation of the image forming apparatus 1 will be described. FIG. 1 is a schematic view showing a cross-sectional structure of the image forming apparatus 1. FIG. 2 is a schematic diagram for illustrating a driving source of the image forming apparatus 1. FIG. 3 is a schematic diagram showing a constitution for supplying toner from a toner cartridge 70 to the developing unit 50.

As shown in FIG. 1, the image forming apparatus 1 includes an image forming apparatus main assembly (hereinafter, referred to as an apparatus main assembly) 1A and toner cartridges 70y, 70m, 70c, and 70k detachably mounted to the apparatus main assembly 1A. The apparatus main assembly 1A is a portion excluding the toner cartridges 70y, 70m, 70c, and 70k from the image forming apparatus 1.

The apparatus main assembly 1A of the image forming apparatus 1 includes an electrophotographic photosensitive member (hereinafter, referred to as a photosensitive drum) 2 having a drum shape (cylindrical shape) as an image bearing member for bearing an electrostatic latent image. At a periphery of the photosensitive drum 2, a charging roller 3, a scanner 4 as an exposure device, and a cleaning unit 6 are provided.

The charging roller 3 is an example of a charging means or charging unit, which is for electrically charging the photosensitive drum 2 uniformly. The scanner 4 is an example of an exposure means or an exposure unit, which is for performing exposure by irradiating the photosensitive drum 2 with laser light depending on image information.

By irradiating the charged photosensitive drum 2 with the laser light, the electrostatic latent image is formed on a surface of the photosensitive drum 2. The cleaning unit 6 is an example of a cleaning portion for removing toner remaining on the surface of the photosensitive drum 2.

Further, the apparatus main assembly 1A includes a sheet accommodating portion 300, a pick-up roller 310, a feed roller 311, a separation roller 312, a conveying roller pair 320, a secondary transfer roller 12, a fixing device 40, and an intermediary transfer unit 10. The pick-up roller 310 is an example of a feeding means or feeding unit, which is for feeding the sheet S. The feed roller 311 and the separation roller 312 are examples of a separation/conveyance unit for conveying sheets S while separating the sheets S one by one by a frictional force. The secondary transfer roller 12 is an example of a transfer means or a transfer unit, which is for transferring an image from an intermediary transfer belt 10a onto the sheet S.

The intermediary transfer unit 10 includes the intermediary transfer belt 10a, a belt driving roller 10b, a tension roller 10c, a cleaning device 13, and a primary transfer roller 11. The intermediary transfer belt 10a is an example of an intermediary transfer member for carrying and conveying an image, transferred (primarily transferred) from the photosensitive drum 2 thereon, in order to transfer (secondarily transfer) the image onto the sheet S. The intermediary transfer belt 10a is stretched by the belt driving roller 10b and the tension roller 10c. The belt driving roller 10b is a driving member for conveying the intermediary transfer belt 10a by being rotationally driven by a driving source.

Further, the apparatus main assembly 1A includes a rotary main body (rotary, rotatable member, developing device) 90 including the developing units 50y, 50m, 50c, and 50k. As described later, in this embodiment, to the rotary main body 90, trays (supporting members) 80y, 80m, 80c, and 80k are mounted. To the trays 80y, 80m, 80c, and 80k, the toner cartridges 70y, 70m, 70c, and 70k are detachably mounted, respectively.

In the following, a plurality of members similar in function can be discriminated by adding reference numerals or symbols. For example, it is possible that one of the four toner cartridges 70y, 70m, 70c, and 70k is referred to as a first toner cartridge, one of the remaining three toner cartridges is referred to as a second toner cartridge, one of the remaining two toner cartridges is referred to as a third toner cartridge, and the final toner cartridge is referred to as a fourth toner cartridge. Similarly, it is possible that one of the four trays 80y, 80m, 80c, and 80k is referred to as a first tray, one of the remaining three trays is referred to as a second tray, one of the two remaining tray is referred to as a third tray, and the final tray is referred to as a fourth tray. That is, one of the trays 80y to 80k is an example of a first supporting member, another one of the trays 80y to 80k is an example of a second supporting member, a further one of the trays 80y to 80k is an example of a third supporting member, and the final one of the trays 80y to 80k is an example of a fourth supporting member. Numbering of these members is merely used for convenience of explanation, and can be appropriately replaced in principle.

The developing units (first to fourth developing units) 50y, 50m, 50c, and 50k are examples of a developing means or a developing portion, which is for developing (visualizing) the electrostatic latent image, formed on the photosensitive drum 2, with toner of an associated one of the colors. The developing units 50y, 50m, 50c, and 50k develop the electrostatic latent images, formed on the photosensitive drums, with yellow toner, magenta toner, cyan toner, and black toner, respectively. The developing units 50y, 50m, 50c, and 50k may be disposed in an order different from the order thereof shown in FIG. 1.

The developing unit 50y includes the developing roller 51y, a supplying roller 52y, and a developing blade. The developing roller 51y is a developer carrying member rotating while carrying the toner as a developer and supplying the toner to the photosensitive drum 2. The supplying roller 52y is a supply member provided in contact with the developing roller 51y and for supplying the tray to the developing roller 51y. The developing blade is a regulating member for regulating a thickness of a layer of the toner carried on the developing roller 51y. Other developing units 50m, 50c, and 50k are provided with developing rollers 51m, 51c, and 51k, supplying rollers 52m, 52c, and 52k, and developing blades similar to those described above.

To the rotary main body 90, the toner cartridge 70y, 70m, 70c, and 70k corresponding to the developing units 50y, 50m, 50c, and 50k. Inside the toner cartridges 70y, 70m, 70c, and 70k, the yellow toner, the magenta toner the cyan toner, and the black toner are accommodated, respectively, as the toner for being supplied to the developing units 50y, 50m, 50c, and 50k, respectively. It is possible that one of the toner of the four colors is first toner, one of the toner of the remaining three colors is referred to as second toner, one of the toner of the remaining two colors is referred to as third toner, and the final toner is referred to as a fourth toner. For example, it can be said that the black toner is an example of the first toner and the magenta toner is an example of the second toner. Numbering of these toner is merely used for convenience of explanation and can be appropriately replaced in principle.

Here, the rotary main body 90 includes a rotary frame 90f for supporting the developing units 50y, 50m, 50c, and 50k. The developing units 50y, 50m, 50c, and 50k are supported by the rotary frame 90f which are rotatable rotation supporting members.

Further, to the rotary main body 90, the trays 80y, 80m, 80c, and 80k are mounted. A portion including the rotary main body 90 and the trays 80y, 80m, 80c, and 80k in combination can be referred to as a rotary unit 90U. In other words, the rotary unit 90U includes the rotary main body 90 and the trays 80y, 80m, 80c, and 80k.

The toner cartridges 70y to 70k are detachably held by the trays 80y to 80k, respectively. Although described later, the tray 80y to 80k are supported slidably and movably to an outside of the rotary main body 90. A portion including the rotary unit 90U and the toner cartridges 70y, 70m, 70c, and 70k in combination can be referred to as a rotary assembly 90A. In other words, the rotary assembly 90A includes the rotary unit 90U and the toner cartridges 70y, 70m, 70c, and 70k.

As described later, the rotary main body 90 is rotatable about the rotational axis (rotation center) 90C. The rotational axis 90C coincides with rotational axes of the rotary frame 90f, the rotary unit 90U, and the rotary assembly 90A. Further, the rotational axis 90C is substantially parallel to a rotational axis (rotation center) of the photosensitive drum 2.

The rotary main body 90 can take a development attitude, in which either one of the developing rollers 51y, 51m, 51c, and 51k opposes the photosensitive drum 2, by being rotated about the rotational axis 90C. An attitude in which the developing roller 51y opposes the photosensitive drum 2 is called a yellow development attitude. An attitude in which the developing roller 51m opposes the photosensitive drum 2 is called a magenta development attitude. An attitude in which the developing roller 51c opposes the photosensitive drum 2 is called a cyan development attitude. An attitude in which the developing roller 51k opposes the photosensitive drum 2 is called a black development attitude. That is, the rotary main body 90 can be rotated about the rotational axis 90C so that positions of the developing rollers 51y, 51m, 51c, and 51k relative to the photosensitive drum 2 change. The black development attitude is an example of a first development attitude in which a first developing roller (developing roller 51k) opposes the photosensitive drum 2. Other development attitudes are examples of a second development attitude in which second developing rollers (developing rollers) 51y to 51c oppose the photosensitive drum 2. The yellow/magenta/cyan/black development attitudes can also be called first to fourth development attitudes. Numbering of these development attitudes is merely used for convenience of explanation and can be appropriately replaced in principle.

As shown in FIG. 2, the apparatus main assembly 1A includes motors M1, M2, and M3 as driving sources. As described later, the motor M1 supplies a driving force for rotating the rotary main body 90 about the rotational axis 90C. In other words, the motor M1 rotates the rotary assembly 90A and the rotary unit 90U about the rotational axis 90C.

Further, the apparatus main assembly 1A includes a driving device 98 including the motor M2 and a transmitting device. The transmitting device includes driving racks 15L and 15R as driving gears described later, and a transmitting portion 15t. A driving force of the motor M2 is transmitted to the driving racks 15L and 15R by the transmitting portion 15t. In other words, the motor M2 is constituted so as to drive the driving racks 15L and 15K and moves the trays 80y, 80m, 80c, and 80k relative to the rotary main body 90 via the driving racks 15L and 15R.

The motor M3 drives members other than the members driven by the motors M1 and M2. For example, the motor M3 drives the photosensitive drum 2, the developing units 50y, 50m, 50c, and 50k, the pick-up roller 310, the feed roller 311, the conveying roller pair 320, the secondary transfer roller 12, the belt driving roller 10b, and the fixing device 40.

Incidentally, the members driven by the motors M1, M2, and M3 can be appropriately changed. Further, functions of arbitrary two of or all of the three motors M1, M2, and M3 can be collected into one motor. On the other hand, a driving source other than the motors M1, M2, and M3 may be added.

Further, the apparatus main assembly 1A includes a controller 30 as a control means for controlling an operation of the image forming apparatus 1. The controller 30 includes a CPU for executing a program and includes a storing portion such as a ROM or a RAM. The CPU reads and execute the program, and controls an operation of actuators such as motors M1, M2, and M3 provided in the image forming apparatus 1. The storing portion includes a non-volatile storing medium and a volatile storing medium, and becomes not only a storage place of the program and data but also a working space when the CPU executes the program. Incidentally, respective functions of the controller 30 described in the following may be implemented, as independent hardware such as an ASIC, for a circuit in the controller 30.

Here, suffixes y, m, c, and k added in the forms such as the developing units 50y, 50m, 50c, and 50k, the toner cartridges 70y, 70m, 70c, and 70k, and the trays 80y, 80m, 80c, and 80k show the colors of the toner. Basic structures and functions of the developing units 50y, 50m, 50c, and 50k are in common. Basic structures and functions of the toner cartridges 70y, 70m, 70c, and 70k are in common. Basic structures and functions of the trays 80y, 80m, 80c, and 80k are in common. Accordingly, in the case where there is no need to distinguish the respective members, the suffixes y, m, c, and k are omitted, and the members will be described as arbitrary one of the four units, the four cartridges, or the four trays. Further, in the case where there is a need to distinguish each of the four units, the four cartridges, or the four trays, the suffixes y, m, c, and k are added to the members, and each of the members will be described as the member corresponding to the associated suffix.

As shown in FIG. 3, the toner cartridge 70 includes a toner frame 71. The toner frame 71 is provided with a toner accommodating portion 71a for accommodating the toner, and a discharge opening 71b communicating with the toner accommodating portion 71a.

The developing unit 50 includes a developing (unit) frame (accommodating frame) 53. The developing frame 53 is provided with a developing-side accommodating portion 53a (accommodating portion) and a receiving opening 53b communicating with the developing-side accommodating portion 53a (toner supplying chamber). That is, the rotary 90 is provided with a developing frame 53k, a developing frame 53m, a developing frame 53c, and a developing frame 53k. That is, the rotary 90 is provided with a first developing chamber, a second developing chamber, a third developing chamber, and a fourth developing chamber. Incidentally, as described above, the developing unit 50 includes the developing roller 51, the supplying roller 52, and the like, but these members are omitted from FIG. 3.

The developing roller 51k provided to the developing unit 50k is an example of a first developing roller. The developing roller 51m provided to the developing unit 50m is an example of a second developing roller. The developing frame 53k (part (a) of FIG. 4) of the developing unit 50k provided with the developing-side accommodating portion 53a (first accommodating portion) is an example of the first accommodating frame provided with the first accommodating portion. The developing frame 53m (part (a) of FIG. 4) of the developing unit 50m provided with the developing-side accommodating portion 53a (first accommodating portion) is an example of the second accommodating frame provided with the second accommodating portion. The rotary main body 90 is an example of a rotatable rotary including the first developing roller, the second developing roller, the first accommodating frame provided with the first accommodating portion, and the second accommodating frame provided with the second accommodating portion. In this embodiment, the rotary main body 90 includes the first to fourth developing rollers and the first to fourth accommodating frames.

As described later, the toner cartridge 70 is movable, relative to the developing frame, to a mounting position and a retracted position retracted from the mounting position. When the toner cartridge 70 is in a state in which the toner cartridge 70 in the mounting position relative to the developing frame, the discharge opening 71b opposes the receiving opening 53b. That is, the toner accommodating portion 71a of the toner cartridge 70 and the developing-side accommodating portion 53a of the developing unit 50 communicate with each other through the discharge opening 71b and the receiving opening 53b. When the tray is supplied from the toner cartridge 70 to the developing unit 50, at least a part of the receiving opening 53b is positioned below at least a part of the discharge opening 71b.

Then, the toner accommodated in the toner accommodating portion 71a is discharged through the discharge opening 71b, and the toner discharged through the discharge opening 71b is accommodated in the developing-side accommodating portion 53a through the receiving opening 53b. That is, the first developer is supplied to the first developing chamber provided to the rotary main body 90, the second developer is supplied to the second developing chamber provided to the rotary main body 90, the third developer is supplied to the third developing chamber provided to the rotary main body 90, and the fourth developer is supplied to the fourth developing chamber provided to the rotary main body 90.

The toner accommodated in the developing-side accommodating portion 53a is supplied to the developing roller 51 by the supplying roller 52. Thus, along a such a path, the toner accommodated in the toner accommodating portion 71a is supplied to the developing roller 51.

The toner cartridge 70 may desirably include an unshown sealing member (first sealing member) for sealing (covering) the discharge opening 71b. Further, the developing unit 50 may desirably include an unshown sealing member (second sealing member) for sealing the receiving opening 53b.

In a state in which the toner cartridge 70 is not mounted to the developing unit 50, each of the discharge opening 71b and the receiving opening 53b may desirably be covered with the associated sealing member so as to suppress flowing-out of the toner through the discharge opening 71b and the receiving opening 53b.

### (Image Forming Operation)

An image forming operation in this embodiment will be described. First, the photosensitive drum 2 is rotated in an arrow direction (counterclockwise direction) of FIG. 1 by being synchronized with rotation of the intermediary transfer belt 10a. Then, a surface of the photosensitive drum 2 is electrically charged uniformly by the charging roller 3.

In the case where a color image is formed on the sheet S, as in the following, the rotary main body 90 rotates in an arrow direction (clockwise direction) of FIG. 1 while supporting the developing units 50y, 50m, 50c, and 50k. Then, an electrophotographic process is repeated while moving the developing rollers 51y, 51m, 51c, and 51k one by one to a developing position.

First, the scanner 4 irradiates the surface of the photosensitive drum 2 with laser light based on image data corresponding to a yellow image, so that an electrostatic latent image corresponding to the yellow image is formed on the surface of the photosensitive drum 2. In parallel to formation of this electrostatic latent image, the motor M1 rotates the rotary main body 90, so that the rotary main body 90 takes the yellow development attitude. When the rotary main body 90 takes the yellow development attitude, the developing roller 51y is in the developing position, so that the electrostatic latent image formed on the photosensitive drum 2 is developed with the yellow toner.

Here, in this embodiment, each of the developing rollers 51y, 51m, 51c, and 51k is an elastic roller in which a metal shaft is coated with a rubber. In the developing position, each of the developing rollers 51y, 51m, 51c, and 51k develops the electrostatic latent image in a state in which each developing roller contacts the photosensitive drum 2. That is, in the image forming apparatus 1 of this embodiment, a contact development type is employed. However, in the developing position, each of the developing rollers 51y, 51m, 51c, and 51k may develop the electrostatic latent image in a state in which a gap is formed between itself and the photosensitive drum 2. That is, the image forming apparatus 1 may employ a non-contact development type.

When the electrostatic latent image is developed into the yellow toner image, the yellow toner image is primarily transferred from the photosensitive drum 2 onto the intermediary transfer belt 10a by the primary transfer roller 11 disposed inside the intermediary transfer belt 10a.

Thereafter, tray images of the respective colors are formed by successively moving the developing rollers 51m, 51c, and 51k through rotation of the rotary main body 90. That is, after the yellow toner image is formed on the intermediary transfer belt 10a, the rotary main body 90 takes the magenta development attitude, and the magenta toner image is formed on the intermediary transfer belt 10a. After the magenta toner image is formed on the intermediary transfer belt 10a, the rotary main body 90 takes the cyan development attitude, and the cyan toner image is formed on the intermediary transfer belt 10a. After the cyan toner image is formed on the intermediary transfer belt 10a, the rotary main body 90 takes the black development attitude, and the black toner image is formed on the intermediary transfer belt 10a. After the black toner image is formed on the intermediary transfer belt 10a, the rotary main body 90 is rotated about the rotational axis 90C is an arrow direction (clockwise direction) shown in FIG. 1, and then returns to the yellow development attitude. Incidentally, a color of the image first formed on the intermediary transfer belt 10a is arbitrary, and for example, the black tray image may be formed first.

Thus, a color image is formed on the intermediary transfer belt 10a by repeating the primary transfer so that the four color toner images are superposed on the intermediary transfer belt 10a. Incidentally, in a period until the color image is formed on the intermediary transfer belt 10a, the secondary transfer roller 12 and the cleaning device 13 do not contact the intermediary transfer belt 10a.

On the other hand, the sheet S is fed by the pick-up roller 310 from the sheet accommodating portion 300 provided at a lower portion of the apparatus main assembly 1A. The sheet S is fed to the conveying roller pair 320 in a state in which the sheets S are separated one by one by the feed roller 311 and the separation roller 312. The conveying roller pair 320 conveys the fed sheet S to a transfer portion (secondary transfer portion) which is a nip between the intermediary transfer belt 10a and the secondary transfer roller 12. The color image on the intermediary transfer belt 10a is transferred (secondarily transferred) onto the surface of the conveyed sheet S.

The sheet S on which the color image is transferred is sent to the fixing device 40. In the fixing device 40, the sheet S is heated and pressed, so that the image is formed on the sheet S. The sheet S passed through the fixing device 40 is discharged to an outside of the image forming apparatus 1.

On the other hand, in the case where a monochromatic image is formed on the sheet S, the rotary main body 90 takes the black development attitude. In this state, after the electrostatic latent image is formed on the surface of the photosensitive drum 2 by the charging and the exposure of the photosensitive drum 2, the electrostatic latent image is developed with the black toner by the developing roller 51k positioned in the developing position. The resultant black toner image is primarily transferred onto the intermediary transfer belt 10a, and then is secondarily transferred onto the sheet S. Subsequent steps are similar to those in the case of the color image.

### (Rotary Constitution)

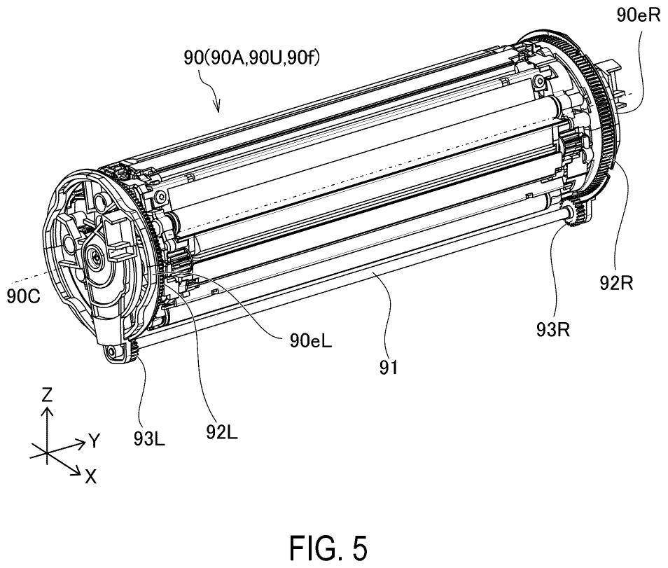

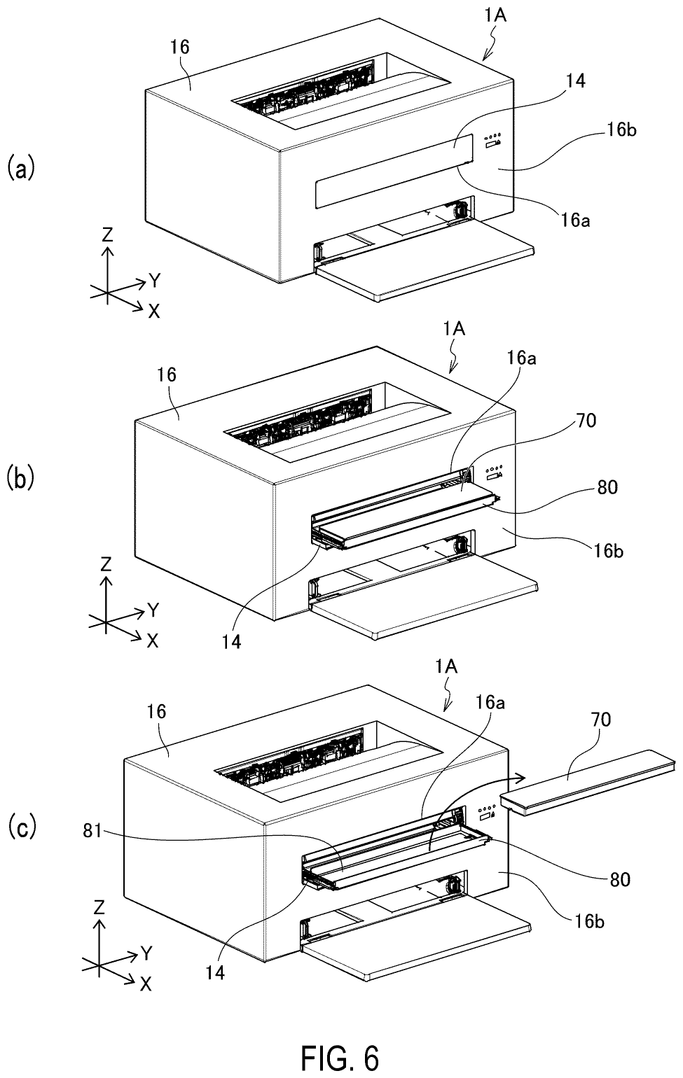

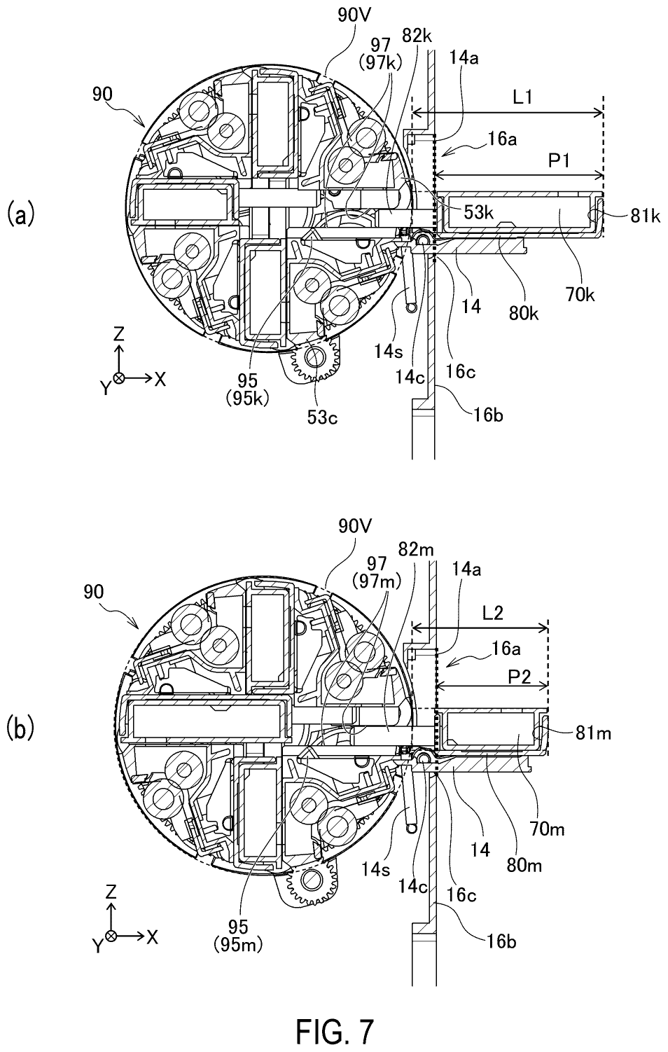

A constitution of the rotary main body 90 will be described using FIG. 1, parts (a) and (b) of FIG. 4, and FIG. 5.

Parts (a) and (b) of FIG. 4 are sectional views showing the rotary main body 90 of the image forming apparatus 1 and a periphery thereof. Incidentally, parts (a) and (b) of FIG. 4 are sectional views in which the apparatus is cut along a virtual flat plane perpendicular to the rotational axis 90C of the rotary main body 90. FIG. 5 is a perspective view of the rotary main body 90.

As described above, the toner cartridges 70y to 70k are detachably mountable to the rotary main body 90. In the case where the tray in each of the toner cartridges 70y to 70k is used up, the tray can be supplied to the image forming apparatus 1 by exchanging the toner cartridges 70y to 70k.

As shown in FIG. 1, the apparatus main assembly 1A includes a frame 16 accommodating the rotary main body 90.

The frame 16 is a main assembly frame of the image forming apparatus 1 of this embodiment. The frame 16 is a casing (frame work) of the apparatus main assembly 1A constituted by a frame or an outer casing member and has a substantially rectangular parallelopiped shape in this embodiment.

The frame 16 is provided with an opening 16a. Specifically, the frame 16 is provided with a side surface 15b extending in a direction crossing a horizontal direction. The side surface 16b constitutes at least a part of an outer appearance surface on +X side of the apparatus main assembly 1A. The opening 16a is disposed in this side surface 16b. The side surface 16b is a surface disposed on a side downstream of a discharge opening with respect to a discharging direction in which the sheet S on which the image is formed is discharged through the discharge opening of the apparatus main assembly 1A. The user is capable of replenishing sheets S by accessing the sheet accommodating portion 300 from a side of the side surface 16b of the image forming apparatus 1 and is capable of obtaining the sheet S discharged through the discharge opening. For that reason, the side surface 16b can be said as a front surface (from side of the apparatus main assembly 1A).

The toner cartridges 70y, 70m, 70c, and 70k are detachably mountable to the rotary main body 90 through the opening 16a. That is, the toner cartridge 70k can be said as an example of a first toner cartridge accommodating the tray supplied to a first developing roller (developing roller 51k) and detachably mountable to the rotary (rotary main body 90) through the opening 16a of the frame 16 of the apparatus main assembly 1A. The toner cartridge 70m can be said as an example of a second toner cartridge accommodating the tray supplied to a second developing roller (developing roller 51m) and detachably mountable to the rotary (rotary main body 90) through the opening 16a of the frame 16 of the apparatus main assembly 1A.

In this embodiment, the toner cartridges 70y, 70m, 70c, and 70k are mounted to and demounted from the rotary main body 90 through the opening 16a in a state in which these toner cartridges 70y to 70k are supported by the trays 80y to 80k. In other words, the user is capable of mounting and demounting the toner cartridges 70y to 70k relative to the rotary main body 90 through the trays 80y to 80k.

The opening 16a is disposed in the side surface 16b of the frame 16. In this embodiment, the side surface 16b is a surface substantially parallel to the rotational axis 90C of the rotary main body 90. For this reason, in the case where the toner cartridge 70 is exchanged, the toner cartridge 70 passes through the opening 16a in a direction crossing (preferably perpendicular to) the rotational axis 90C.

The image forming apparatus 1 includes a door 14 covering the opening 16a of the frame 16. The door 14 is an openable (/closable) member movable to a closed position where the door 14 covers the opening 16a (see also part (a) of FIG. 6) and an open position where the door 14 exposes the opening 16a (see also parts (b) and (c) of FIG. 6).

As described above, in this embodiment, the toner cartridge 70 is constituted so as to be detachably mountable to the rotary main body 90 through the tray 80. For this reason, the toner cartridge 70 can be stably mounted to and demounted from the rotary main body 90.

Specifically, the user is capable of exchanging the toner cartridge 70 by an operation of mounting and demounting the toner cartridge 70 relative to the tray 80 constituted so as to be movable relative to the rotary main body 90 (i.e., relative to the apparatus main assembly 1A). In the case of a constitution in which the user exchanges the toner cartridge by directly inserting and extracting the toner cartridge relative to the apparatus main assembly, the user is required to insert the toner cartridge to a predetermined mounting position in the apparatus main assembly. In this embodiment, in a state in which the tray 80 supports the toner cartridge 70, the tray 80 is movable so that the toner cartridge 70 is moved to the mounting position. For that reason, the user is capable of exchanging the toner cartridge 70 by a simple operation of placing the toner cartridge 70 on the tray 80, so that an operating property is improved.

Incidentally, the toner cartridge 70 has a thin and elongated shape with respect to Y direction, as a longitudinal direction, parallel to the rotational axis 90C of the rotary main body 90. That is, a dimension of the toner cartridge 70 in the longitudinal direction is more than a height and a width in a cross section perpendicular to the longitudinal direction. Thus, in the case where the toner cartridge 70 having the thin and elongated shape is handled, by disposing the opening 16a in the side surface 16b of the frame 16 substantially parallel to the longitudinal direction (Y direction) of the toner cartridge 70, the toner cartridge 70 is capable of being passed through the opening 16a in a short movement distance. For example, the exchange of the toner cartridge becomes easy compared with the case where the toner cartridge 70 is inserted and extracted through an opening provided in a side surface on either one side (+Y side or −Y side) of the frame 16 with respect to the longitudinal direction of the toner cartridge 70.

The rotary main body 90 is capable of taking an exchange attitude in which demounting (removal) of either one of the toner cartridges 70y to 70k from the rotary main body 90 is permitted by being rotated about the rotational axis 90C. An attitude in which the demounting of the toner cartridge 70y is permitted is called a yellow exchange attitude. An attitude in which the demounting of the toner cartridge 70m is permitted is called a magnetic exchange attitude. An attitude in which the demounting of the toner cartridge 70c is permitted is called a cyan exchange attitude. An attitude in which the demounting of the toner cartridge 70k is permitted is called a black exchange attitude. The black exchange attitude is an example of a first exchange attitude in which the demounting of the first toner cartridge from the rotary main body 90 is permitted. Each of the yellow/magenta/cyan exchange attitudes is an example of a second exchange attitude in which the demounting of the second toner cartridge from the rotary main body 90 is permitted. The yellow/magenta/cyan/black exchange attitudes can also be called first to fourth exchange attitudes, respectively. Numbering of these exchange attitudes is merely used for convenience of explanation and can be appropriately replaced in principle.

The rotary main body 90 is rotated about the rotational axis 90C in the clockwise direction in FIG. 1, so that the rotary main body 90 is capable of successively taking the yellow/magenta/cyan/black exchange attitudes. In this embodiment, the rotary main body 90 is rotated about the rotational axis 90C in the clockwise direction in FIG. 1, so that the development attitude and the exchange attitude are alternately switched. For example, in FIG. 1, the rotary main body 90 takes the black development attitude. From this state, the rotary main body 90 is rotated clockwise, so that the attitude of the rotary main body 90 is switched in the order of the cyan exchange attitude, the yellow development attitude, the black exchange attitude, the magenta development attitude, the yellow exchange attitude, the cyan development attitude, and the magenta exchange attitude. The rotary main body 90 is rotated clockwise from the magenta exchange attitude, so that the attitude of the rotary main body 90 returns to the black development attitude. That is, the rotary main body 90 can be rotated clockwise one-full turn (360°) or more.

Part (a) of FIG. 4 shows a cross section of the rotary main body 90 in a state in which the rotary main body 90 takes the development attitude (specifically, the yellow development attitude). Part (b) of FIG. 4 shows a cross section of the rotary main body 90 in a state in which the rotary main body 90 takes the exchange attitude (specifically, the black exchange attitude).

As shown in parts (a) and (b) of FIG. 4, to the rotary main body 90, the four trays 80y to 80k are mounted. On the trays 80y to 80k, the toner cartridges 70y to 70k are held, respectively. In parts (a) and (b) of FIG. 4, the trays 80y to 80k are in a state in which these trays are accommodated inside the rotary main body 90, and this state can also be said as a state in which the toner cartridges 70y to 70k are mounted to the developing units 50y to 50k, respectively.

As described above, the toner cartridge 70 is movable to the mounting position relative to the developing frame 53 of the developing unit 50 and the retracted position retracted from the mounting position. That is, the first toner cartridge (toner cartridge 70k) is movable to a first mounting position and a first retracted position relative to the first accommodating frame (developing frame 53k). The second toner cartridge (toner cartridge 70m) is movable to a second mounting position and a second retracted position relative to the second accommodating frame (developing frame 53m).

In a state in which the toner cartridge 70 is in the mounting position relative to the developing frame 53, as shown in FIG. 3, the discharge opening 71b and the receiving opening 53b oppose each other. In this state, the toner cartridge 70 is constituted so as to supply the toner to the developing-side accommodating portion 53a through the receiving opening 53b (opening of the accommodating frame).

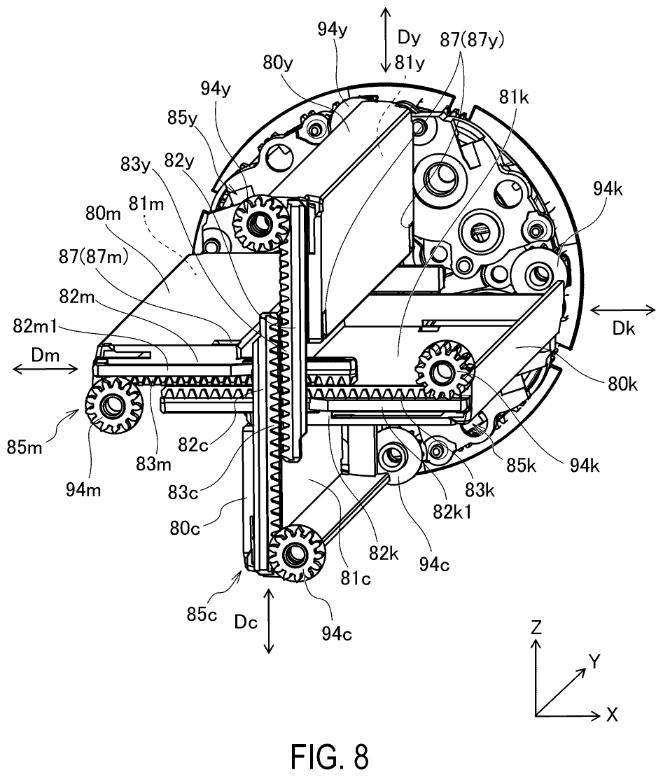

The apparatus main assembly 1A includes a moving device 85 constituted so as to move the toner cartridge 70 from the mounting position to the retracted position relative to the rotary main body 90 (specifically, the developing frame 53 of the developing unit 50). The moving device 85 will be described later using FIG. 8 and the like. In this embodiment, in the rotary main body 90, a plurality of moving devices 85y to 85k corresponding to the plurality of toner cartridges 70y to 70k, respectively, are provided. The trays 80y to 80k can be said as parts of these moving devices 85y to 85k, respectively.

In this embodiment, the toner cartridge 70k accommodating the black toner is larger in size than each of the toner cartridges 70y to 70c accommodating the yellow toner, the magenta toner, and the cyan toner, respectively, and is capable of accommodating the toner in a large amount. In other words, the first toner cartridge is capable of accommodating the toner in a first amount and the second toner cartridge is capable of accommodating the toner in a second amount, and it can be said that the first amount is larger than the second amount.

Specifically, a length of the toner cartridge 70k for black in a first radial direction relative to the rotational axis 90C of the rotary main body 90 is longer than a length of the toner cartridge 70m for magenta in a second radial direction. Here, the first radial direction is a direction which is a rotation radius direction of the rotary main body 90 (radial direction of a virtual circle about the rotational axis 90C) and in which the toner cartridge 70k extends relative to the rotational axis 90C as viewed in a direction of the rotational axis 90C. The second radial direction is a direction which is a rotation radius direction of the rotary main body 90 and in which the toner cartridge 70m extends relative to the rotational axis 90C as viewed in the direction of the rotational axis 90C. Similarly, the length of the toner cartridge 70k for black in the first radius direction is longer than lengths of other toner cartridges 70y and 70c in radial directions corresponding to the toner cartridges 70y and 70c.

For that reason, the tray 80k holding the toner cartridge 70k for black is larger in size than each of the trays 80y to 80c holding other toner cartridges 70y to 70c, respectively. That is, in the rotary main body 90, the four toner cartridges 70y to 70k and the four trays 80y to 80k, which are different in size are disposed. In other words, to the rotary main body 90, the toner cartridge 70k as the example of the first toner cartridge and the toner cartridge 70y as the example of the second toner cartridge smaller in size than the first toner cartridge are detachably mountable. Correspondingly thereto, in the rotary main body 90, the tray 80k as an example of the first supporting member for supporting the first toner cartridge and the tray 80y as an example of the second supporting member smaller in size than the first supporting member are provided. Further, to the rotary main body 90, the toner cartridges 70m and 70c as examples of the third toner cartridge and the fourth toner cartridge which are smaller in size than the first toner cartridge are detachably mountable. Correspondingly thereto, in the rotary main body 90, the trays 80m and 80c as examples of the third supporting member and the fourth supporting member which are smaller in size than the first supporting member are provided.

Here, rotational drive of the rotary main body 90 will be described using FIG. 5. As shown in FIG. 5, disk gears 92L and 92R are formed in opposite end portions of the rotary main body 90. Further, to opposite end portions of a swing shaft 91, rotary driving gears 93L and 93R are connected in a drive transmittable manner. Here, a driving force of the motor M1 is transmitted to the rotary driving gear 93R by a drive transmitting mechanism. Then, the driving force is transmitted to the disk gears 92L and 92R by the rotary driving gears 93L and 93R, respectively, so that the rotary main body 90 is rotationally driven. The rotary main body 90 is rotated about the rotational axis 90C in the clockwise direction of FIG. 1.

Further, the rotary main body 90 is swingably supported about the swing shaft 91. The rotary main body 90 is urged about the swing shaft 91 in the counterclockwise direction in parts (a) and (b) of FIG. 4 by an unshown urging member. This direction can be said as a direction in which each of the developing rollers 51y to 51k approaches the photosensitive drum 2. As a result, in a state in which the rotary main body 90 takes the development attitude, each of the developing rollers 51y to 51k contacts the photosensitive drum 2.

On the other hand, as shown in FIG. 5, to the opposite end portions of the rotary main body 90, rotary cams 90eL and 90eR are provided. When the rotary main body 90 is rotated about the rotational axis 90C in the clockwise direction in parts (a) and (b) of FIG. 4, the rotary cams 90aL and 90eR contact a roller 96 (parts (a) and (b) of FIG. 4) supported by the frame 16. Then, the rotary main body 90 is moved about the swing shaft 91 in the clockwise direction in parts (a) and (b) of FIG. 4. This direction can be said as a direction in which each of the developing rollers 51y to 51k is moved away from the photosensitive drum 2. Further, this direction can be said as a direction in which the rotary main body 90 approaches the opening 16a and the door 14 of the frame 16.

By this, when the rotary main body 90 is rotated and the attitude thereof is switched from the development attitude to the exchange attitude, the rotary main body 90 is swung about the swing shaft 91. In a state in which the rotary main body 90 takes the exchange attitude, the developing roller 51 is separated from the photosensitive drum 2.

As shown in part (b) of FIG. 4, in the block exchange attitude, the toner cartridge 70k stops at a position opposing the opening 16a and the door 14 which are provided in the side surface 16b of the apparatus main assembly 1A. From this state, when the tray 80k is slid and moved from the mounting position to the developing unit 50k to an outside of the rotary main body 90, the user is capable of exchanging the toner cartridge 70k.

### (Exchanging Operation of Toner Cartridge)

A toner cartridge exchanging operation will be described using part (a) of FIG. 4, parts (a) to (c) of FIG. 6, and parts (a) and (b) of FIG. 7. Parts (a) to (c) of FIG. 6 are outer appearance views of the image forming apparatus 1. Parts (a) and (b) of FIG. 7 are sectional views of a periphery of the rotary main body 90 during the exchange of the toner cartridge. Incidentally, parts (a) and (b) of FIG. 7 are sectional views of the apparatus in a virtual flat plane perpendicular to the rotational axis 90C of the rotary main body 90.

Part (a) of FIG. 6 shows an outer appearance of the apparatus main assembly 1A during the image forming operation and in a stand-by state. During the image forming operation is during an execution period of a series of operations until the sheet S is discharged as a product after the image is formed on the sheet S fed by the image forming apparatus 1. The stand-by state is a state in which the image forming operation is capable of being started in the case where the image forming apparatus 1 receives an image forming instruction (print instruction) and in which the image forming apparatus 1 waits for the image forming instruction from the user. As shown in part (a) of FIG. 6, during the image forming operation and in the stand-by state, the door 14 is in a closed state.

Part (b) of FIG. 6 shows an outer appearance of the apparatus main assembly 1A during the exchange of the toner cartridge. During the toner cartridge exchange, the door 14 is put in an open state, and the tray 80 and the toner cartridge 70 are moved to the outside of the apparatus main assembly 1A.

The toner cartridge 70 is movable, relative to the developing frame 53 of the developing unit 50, to the mounting position and the retracted position retracted from the mounting position. In a state in which the toner cartridge 70 is in a state in which the toner cartridge 70 is in the mounting position relative to the developing frame 53, as shown in FIG. 3, the discharge opening 71b and the receiving opening 53b oppose each other. As shown in parts (a) and (b) of FIG. 4, the rotary main body 90 is rotated about the rotational axis 90C in the state in which the toner cartridge 70 is in the mounting position, and is constituted to take the development attitude and the exchange attitude.

An exchanging operation of the toner cartridge will be described. First, the user provides an instruction to the controller 30 (FIG. 2) of the apparatus main assembly 1 so as to perform the toner cartridge exchanging operation. The instruction to perform the toner cartridge exchanging operation is carried out by input through, for example, an operating panel (operating portion) provided on the apparatus main assembly 1A.

When the controller 30 receives the instruction of the toner cartridge exchanging operation, the rotary main body 90 is rotated to the exchange attitude of the toner cartridge 70 (toner cartridge 70 which is used up) which is an exchange object, and then the rotation of the rotary main body 90 is stopped. That is, the controller 30 causes the rotary main body 90 to be rotated to the exchange attitude (black exchange attitude for permitting exchange of the toner cartridge 70k for black in part (b) of FIG. 4) of the toner cartridge designated by the instruction of the toner cartridge exchanging operation. In the exchange attitude, the tray 80 supporting the toner cartridge 70 instructed so as to be exchanged opposes the opening 16a of the frame 16 of the apparatus main assembly 1A.

For example, the rotary main body 90 of part (a) of FIG. 4 is in the development attitude in which the yellow developing roller 51y opposes the photosensitive drum 2. At this time, the toner cartridge 70k for black and the tray 80k for black do not need to oppose the opening 16a and the door 14. In other words, the toner cartridge 70 and the tray 80 do not need to oppose the opening 16a and the door 14 in the case where the rotary main body 90 is in the exchange attitude other than the associated toner cartridge or in the development attitude. For that reason, the opening 16a may only be required to have a size such that each toner cartridge 70 is capable of individually passing through the opening 16a. When the rotary main body 90 is rotated from the yellow development attitude in the clockwise direction in part (a) of FIG. 4 by a predetermined angle, as shown in part (b) of FIG. 4, the toner cartridge 70k for black and the tray 80k for black oppose the opening 16 and the door 14.

Here, the “tray 80k opposes the opening 16a” means that the tray 80k is positioned so as to become movable to the outside of the apparatus main assembly 1A through the opening 16a. That is, in the case where the tray 80 opposes the opening 16a, the tray 80 is moved by moving mechanism described later to the outside of the rotary main body 90 in the rotation radius direction, so that the tray 80 and the toner cartridge 70 supported by the tray 80 is capable of being projected to the outside of the apparatus main assembly 1A. In part (a) of FIG. 4, either one of the trays 80y to 80k does not oppose the opening 16a. In part (b) of FIG. 4, only the tray 80k for black opposes the opening 16a, and other trays 80y to 80c do not oppose the opening 16a.

When the rotary main body 90 is positioned in the exchange attitude, by the motor M2, the tray 80 supporting the toner cartridge 70 which is an exchange object is moved toward the outside of the apparatus main assembly 1A.

By this, the toner cartridge 70 which is the exchange object is moved from the mounting position toward the retracted position relative to the rotary main body 90. Further, as shown in parts (a) and (b) of FIG. 6 and parts (a) and (b) of FIG. 7, the tray 80 and the toner cartridge 79 which is the exchange object supported by the tray 80 are projected to the outside of the apparatus main assembly 1A through the opening 16a.

Specifically, the tray 80 is movable to an accommodating position and a taking-out position relative to the rotary main body 90. That is, the first tray is movable to the accommodating position and the taking-out position relative to the rotary main body 90. Further, the second tray is movable to the accommodating position (third position) and the taking-out position (fourth position) relative to the rotary main body 90. The accommodating position is a position where the tray 80 is accommodated in the rotary main body 90. The taking-out position is a position (demounting position, exchangeable position) where at least a part of the tray 80 is projected (exposed) to the outside of the rotary main body 90 and where the toner cartridge 70 is capable of being taken out from the tray 80. An example of the accommodating position includes positions of the trays 80y to 80k of parts (a) and (b) of FIG. 4. An example of the taking-out position includes positions of the tray 80 of parts (b) and (c) of FIG. 6, the tray 80k of part (a) of FIG. 7, and the tray 80m of part (b) of FIG. 7.

When the tray 80 is in the accommodating position, the toner cartridge 70 mounted on the tray 80 is positioned inside the rotary main body 90 and positioned in the mounting position. When the tray 80 is in the taking-out position, the toner cartridge 70 mounted on the tray 80 is positioned outside the rotary main body 90 and positioned in the retracted position.

Here, as shown in parts (a) and (b) of FIG. 7, the rotary main body 90 includes a projected portion 95 for holding the tray 80 in the accommodating position and for holding the toner cartridge 70 in the mounting position. As shown in FIG. 8, the tray 80 is provided with a recessed portion 87 engaged with the projected portion 95. The projected portions 95k and 95m corresponding to the trays 80k and 80m are shown in parts (a) and (b) of FIG. 7, and the recessed portions 87y and 87m of the trays 80y and 80m are shown in FIG. 8, but the projected portion 95 and the recessed portion 87 are provided for each of the trays 80y to 80k. The projected portion 95 may preferably be urged in a direction in which the projected portion 95 engages with the recessed portion 87.

The projected portion 95 engages with the recessed portion 87 of the tray 80, so that the tray 80 is locked to the rotary frame 90f. By this, even when the rotary main body 90 is rotated, the tray 80 remains in the accommodating position, so that the toner cartridge 70 is prevented from moving from the mounting position. Incidentally, in the case where the tray 80 is moved between the accommodating position and the taking-out position by the moving device described later, it is possible to employ a constitution in which the projected portion 95 is moved by the tray 80 and thus is disengaged from the recessed portion 87.

In this embodiment, the door 14 is rotatably supported by the apparatus main assembly 1A. As shown in part (a) of FIG. 7, the door 14 is urged from the open position to the closed position by a spring 14s. The spring 14s is, for example, a tension spring and urges the door 14 so as to generate movement about a supporting shaft 14c of the door 14 in the counterclockwise direction in parts (a) and (b) of FIG. 7.

The tray 80 pushes the door 14, whereby the door 14 is put in an open state (state of part (b) of FIG. 6). This state can also be said as a state in which the tray 80 is supported by the door 14. At least a part of the tray 80 projected to the outside of the apparatus main assembly 1A is supported by the door 14, so that the toner cartridge 70 can be supported more stably. In other words, when the first toner cartridge (toner cartridge 70k) is in a first retracted position, the openable member (door 14) in the open position supports the first supporting member (tray 80k). Further, when the second toner cartridge (toner cartridges 70y to 70c) is in a second retracted position, the openable member (door 14) in the open position supports the second supporting member (trays 80y to 80c).

Incidentally, the door 14 is constituted so that the door 14 contacts a part (for example, a lower edge 16c of the opening 16a) of the frame 16 of the apparatus main assembly 1A in the open position and is not rotated downward beyond the open position. When the tray 80 is pulled back from the outside to the inside of the apparatus main assembly 1A, the position of the door 14 is returned to the closed position by an urging force of the spring 14s.

The toner cartridge 70 is detachably held on the tray 80. For that reason, as shown in part (c) of FIG. 6, the user is capable of performing an operation (exchanging operation) such that the toner cartridge 70 is demounted (removed) from the tray 80 and then a new toner cartridge 70 is mounted (attached) to the tray 80. Incidentally, in the case where a plurality of toner cartridges 70 are exchanged, the exchanging operation can be performed by repeating the above-described operation.

Parts (a) and (b) of FIG. 7 each shows a cross section of the rotary main body 90 and a periphery thereof during the exchange of the toner cartridge.

Part (a) of FIG. 7 shows a state during the exchange of the toner cartridge 70k for black. Part (b) of FIG. 7 shows a state during the exchange of the toner cartridge 70m for magenta.

The image forming apparatus 1 is provided with the moving devices 85y, 85m, 85c, and 85k (FIG. 8) for moving the toner cartridges 70y, 70m, 70c, and 70k from the mounting position to the retracted position. In the case where the moving device is referred to as the “moving device 85” by omitting the suffixes, the moving device 85 usually shows an arbitrary one of the moving devices 85y, 85m, 85c, and 85k. In this embodiment, the moving device 85 can be said to include the tray 80. The moving device 85k including the tray 80k can be said as an example of a first moving device including the first supporting member. The moving device 85m including the tray 80m can be said as an example of a second moving device including the second supporting member.

Even in a state in which the toner cartridge 70 is in the retracted position, the tray is in a state in which the tray 80 is connected to the rotary main body 90 (state in which the tray 80 is supported by the rotary main body 90). In order to readily perform an operation for demounting the toner cartridge 70 from the rotary main body 90, in the retracted position, a projection length of the toner cartridge 70 from the rotary main body 90 may preferably be long. The toner cartridge 70 is constituted so as to be detachably mounted to the rotary main body 90 through the tray 80, and therefore, even in the case where the projection length of the toner cartridge 70 from the rotary main body 90 is long, the toner cartridge 70 can be stably supported by the tray 80.

A movement direction of the toner cartridge 70 when the toner cartridge 70 is moved from the mounting position to the retracted position is called a retracting direction. In this embodiment, the retracting direction of the toner cartridge 70 is a direction crossing a direction (Y direction) of the rotational axis 90C. Accordingly, as shown in parts (a) and (b) of FIG. 7, as viewed in the direction (Y direction) of the rotational axis 90C, the retracting direction of the toner cartridge 70 is a direction perpendicular to the direction (Y direction) of the rotational axis 90C. Further, the retracting direction of the toner cartridge 70 can be said as a direction (direction away from the rotational axis 90C) toward the outside of the rotary main body 90 with respect to the rotation radius direction.

As shown in parts (a) and (b) of FIG. 7, in order to perform a demounting operation of the toner cartridge 70 from the rotary main body 90 by the user, during the demounting of the toner cartridge 70, at least a part of the toner cartridge 70 may preferably be projected from the rotary main body 90. In this embodiment, when the toner cartridge 70 is in the retracted position, a whole of the toner cartridge 70 is projected from the rotary main body 90.

When the rotary main body 90 is rotated about the rotational axis 90C, a rotation locus of the rotary main body 90 can be said to coincide with a circumscribed circle (a virtual circle 90V indicated by a broken line in parts (a) and (b) of FIG. 7) of the rotary main body 90 about the rotational axis 90C. When the toner cartridge 70 is in the retracted position, it is preferable that a half or more of a length of the toner cartridge 70 in the retracting direction is in an outside of the rotation locus of the rotary main body 90. That is, as viewed in the rotation axis direction, in the state in which the toner cartridge is in the retracted position, with respect to a movement direction of the toner cartridge from the mounting position to the retracted position, it is preferable that a half or more of a full-length of the toner cartridge is positioned outside the rotation locus of the rotary. This applies to the toner cartridges 70 including the toner cartridge 70k as an example of the first cartridge and the toner cartridge 70m as an example of the second cartridge. Further, in this embodiment, as shown in each of parts (a) and (b) of FIG. 7, when the toner cartridge 70 is in the retracted position, a whole of the toner cartridge 70 is in the outside of the rotation locus (virtual circle 90V) of the rotary main body 90.

Further, in order that the user readily grips the toner cartridge 70, when the toner cartridge 70 is in the retracted position, at least a part of the toner cartridge 70 may preferably be in an apparatus outside of the image forming apparatus 1 (apparatus outside of the apparatus main assembly 1A). Here, the “apparatus outside” refers to a space on the outside of the image forming apparatus 1 (outside of the apparatus main assembly 1A) when the image forming apparatus is used, for example, in the image forming operation for forming the image on the sheet S.

In this embodiment, an outer appearance surface of the apparatus main assembly 1A is formed by an outer appearance surface of the frame 16. That is, the apparatus outside can also be said as an outside of the frame 16. Accordingly, a state in which at least the part of the toner cartridge 70 is in the apparatus outside can also be said as a state in which at least the part of the toner cartridge 70 is projected toward the outside of the frame 16 through the opening 16a of the frame 16 of the apparatus main assembly 1A.

In this embodiment, when the door 14 is in the closed position, the opening 16a of the frame 16 of the apparatus main assembly 1A is covered with the door 14. Further, by an outer appearance surface 14a of the door 14 in the closed position, a part of the outer appearance surface of the apparatus main assembly 1A is formed. In this case, the apparatus outside refers to an outside of the outer appearance surface 14a of the door 14 in the closed position. That is, in the case where a position of the outer appearance surface 14a of the door 14 in the closed position is an outer appearance position, when the toner cartridge 70 is in the retracted position, at least the part of the toner cartridge 70 is positioned outside of the apparatus main assembly 1A than this outer appearance position.

In other words, if the door 14 is in the closed position, at least the part of the toner cartridge 70 is positioned in a space outside the apparatus main assembly 1A. Further, with respect to the retracting direction of the toner cartridge 70, at least the part of the toner cartridge 70 is positioned on a side downstream of the outer appearance position.

Further, in the case where the side surface 16b provided with the opening 16a is a front surface of the apparatus main assembly 1A, when the toner cartridge 70 is in the retracted position, at least the part of the toner cartridge 70 can be said to be projected toward a front surface side than the outer appearance surface on the front surface side of the apparatus main assembly 1A. In this case, the user is capable of easily performing the exchanging operation of the toner cartridge 70 by accessing the toner cartridge 70 from the front surface side of the image forming apparatus 1.

Incidentally, when the toner cartridge 70 is in the retracted position, a half or more of the length of the toner cartridge 70 in the retracting direction may preferably be on the apparatus outside. That is, as viewed in the rotation axis direction of the rotary, in the state in which the toner cartridge is in the retracted position, with respect to the movement direction of the toner cartridge from the mounting position toward the retracted position, a half or more of the full-length of the toner cartridge may preferably be positioned outside the main assembly frame. This applies to the toner cartridges including the toner cartridge 70k as the example of the first cartridge and the toner cartridge 70m as the example of the second cartridge. Further, when the toner cartridge 70 is in the retracted position, it is preferable that the whole of the toner cartridge 70 is positioned on the apparatus outside. Incidentally, in this embodiment, the outer appearance surface on the front surface side of the apparatus main assembly 1A is formed by the outer appearance surface 14a of the door 14 and the side surface 16b, but the constitution of the door 14 is not limited thereto. For example, a size of the door 14 may be made a size such that the door 14 covers a whole of the side surface 16b. In this case, the outer appearance surface on the front surface side of the apparatus main assembly 1A is formed by the outer appearance surface 14a of the door 14.

The tray 80 is provided with a cartridge holding portion 81 (see FIG. 3 and part (c) of FIG. 6 for holding the toner cartridge 70. The cartridge holding portion 81 is a mounting portion to which the toner cartridge 70 is mounted. When the tray 80 is in the taking-out position, with respect to the retracting direction, a whole of the cartridge holding portion 81 may preferably be positioned outside the rotation locus of the rotary main body 90. When the tray 80 is in the taking-out position, with respect to the retracting direction, a half or more of the length of the cartridge holding portion 81 may preferably be positioned on the apparatus outside.

Here, as described above, the toner cartridge 70k and the tray 80k are large in size than other combinations of the toner cartridge 70y and the tray 80k, the toner cartridge 70m and the tray 80k, and the toner cartridge 70c and the tray 80c. For that reason, as shown in parts (a) and (b) of FIG. 7, in this embodiment, correspondingly to a size of the toner cartridge 70, a movement amount of the tray 80 during the toner cartridge exchange is changed.

Specifically, as shown in part (a) of FIG. 7, a movement distance when the tray 80k (first supporting member) is moved from the accommodating position (first accommodating position) to the taking-out position (first taking-out position) is L1. A movement distance when the tray 80m (second supporting member) is moved from the accommodating position (second accommodating position) to a taking-out position (second taking-out position) is L2. In part (b) of FIG. 2, a state in which the toner cartridge 70m and the tray 80m are moved is shown, but a movement distance when each of the trays 80y and 80c is moved from the accommodating position to the taking-out position is also L2. At this time, L1 is longer than L2. In other words, it can be said that the movement distance of the first supporting member when the first toner cartridge is moved from the first mounting position to the first retracted position is longer than the movement distance of the second supporting member when the second toner cartridge is moved from the second mounting position to the second retracted position.

Further, as shown in part (a) of FIG. 7, in a state in which the tray 80k is in the taking-out position and the toner cartridge 70k is in the retracted position, the toner cartridge 70k is projected from the outer appearance surface of the apparatus main assembly 1A to the apparatus outside by a distance P1. In this embodiment, the tray 80k is also projected from the outer appearance surface of the apparatus main assembly 1A to the apparatus outside by the distance P1.

Further, as shown in part (b) of FIG. 7, in a state in which the tray 80m is in the taking-out position and the toner cartridge 70m is in the retracted position, the toner cartridge 70m is projected from the outer appearance surface of the apparatus main assembly 1A to the apparatus outside by a distance P2. In this embodiment, the tray 80m is also projected from the outer appearance surface of the apparatus main assembly 1A to the apparatus outside by the distance P2. Incidentally, each of the toner cartridges 70y and 70c is also projected from the outer appearance surface of the apparatus main assembly 1 to the apparatus outside by the distance P2.

The distance P1 is longer than the distance P2. That is, a length in which the first toner cartridge in the first retracted position is projected through the opening 16a of the apparatus main assembly 1A is a first length (P1), and a length of the second toner cartridge in the second retracted position is projected through the opening 16a is a second length (P2). In this case, it can be said that the first length is longer than the second length.

Each of the toner cartridges 70y to 70c small in size compared with the toner cartridge 70k is preferable from a viewpoint of strength when the distance P2 in which each of the toner cartridges 70y to 70c is projected to the apparatus outside in the retracted position is made shorter than the distance P1 in which the toner cartridge 70k is projected to the apparatus outside in the retracted position. This is because of the following reason. When the toner cartridge 70 is positioned in the retracted position, at least a part of the toner cartridge 70 is projected to the outside of the rotation locus of the rotary main body 90 or the apparatus outside through the outer appearance surface of the apparatus main assembly 1A. At this time, the tray 80 supports a weight of the toner cartridge 70 in a state in which the tray 80 is cantilever-supported by the rotary main body 90. For that reason, when the distance P2 in which the toner cartridges 70y to 70c are projected to the apparatus outside in the retracted position is made short, a load exerted on the trays 80y to 80c and the guiding portion 97 of the rotary main body 90 supporting the trays 80y to 80k can be reduced. Further, each of the toner cartridges 70y to 70c is small in size compared with the toner cartridge 70k, so that even the distance p2 is made shorter than the distance P1, an operation property of the cartridge exchange for the trays 80y to 80c can be maintained.

### (Tray Arrangement in Rotary)

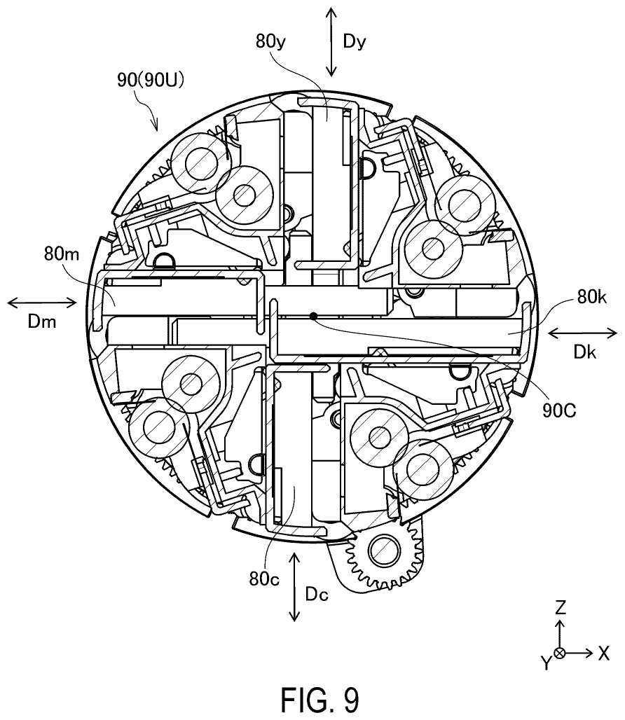

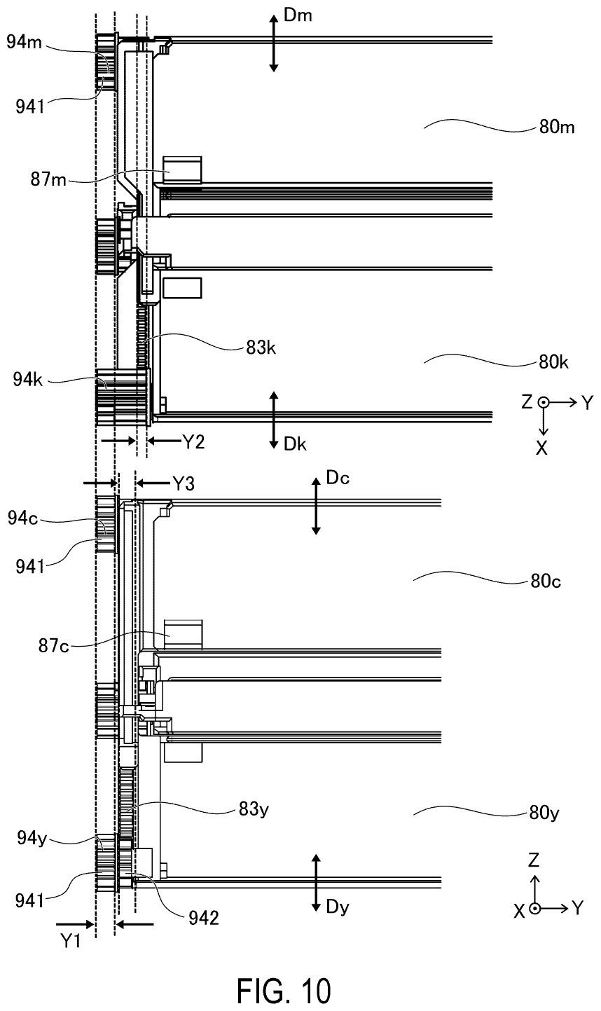

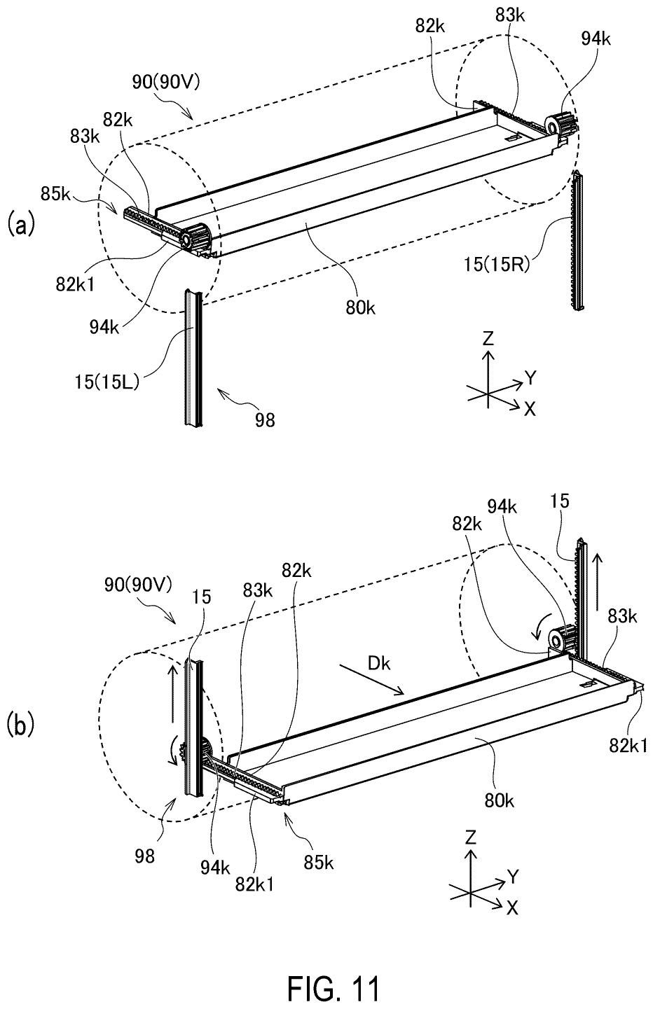

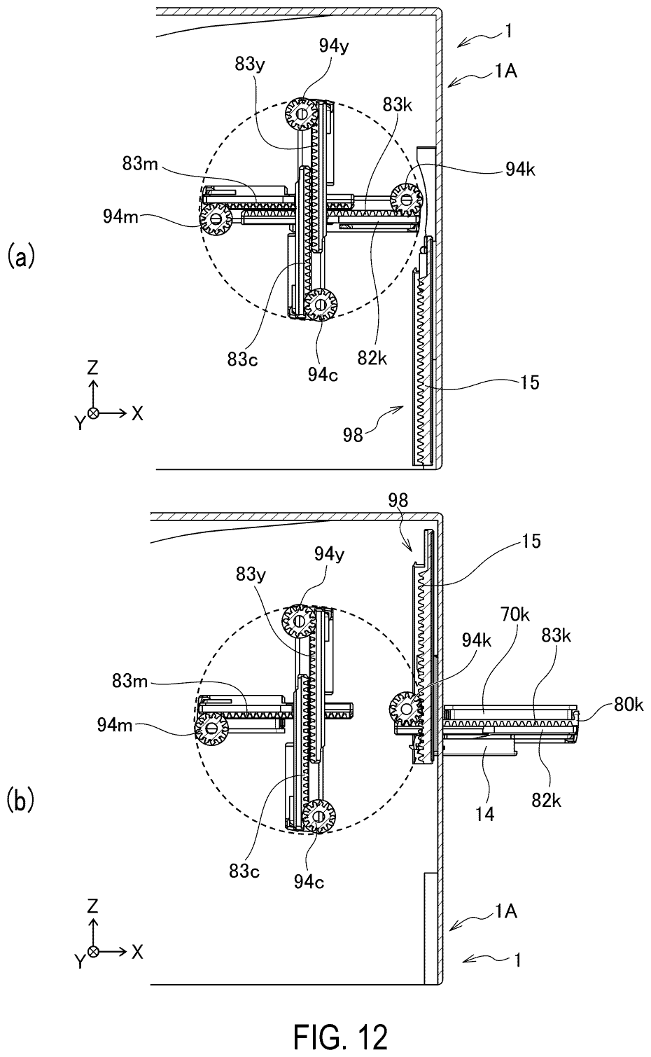

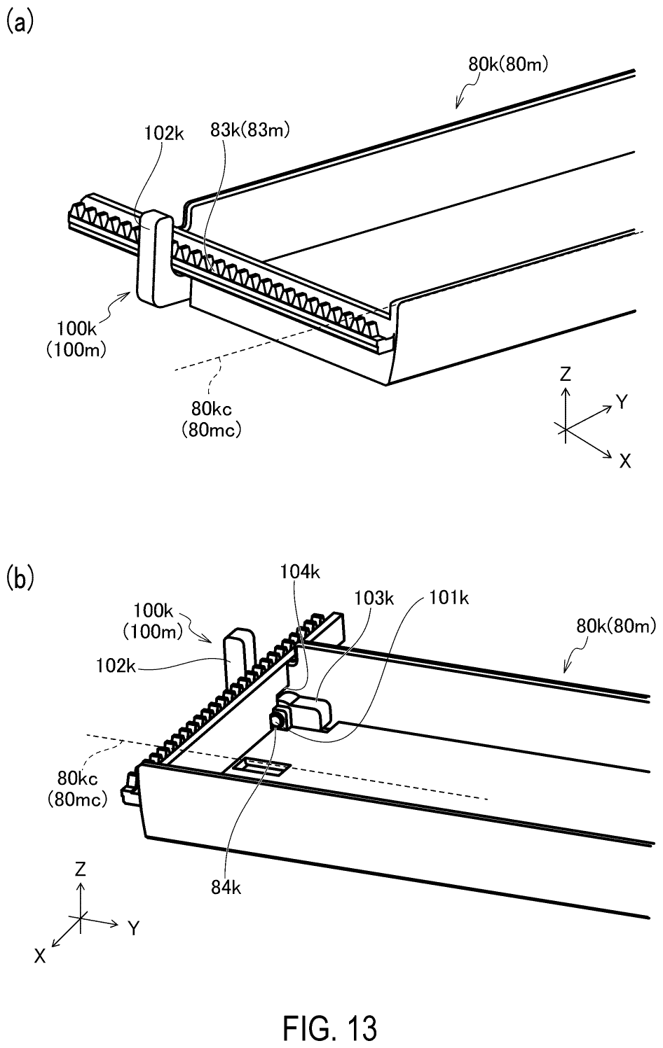

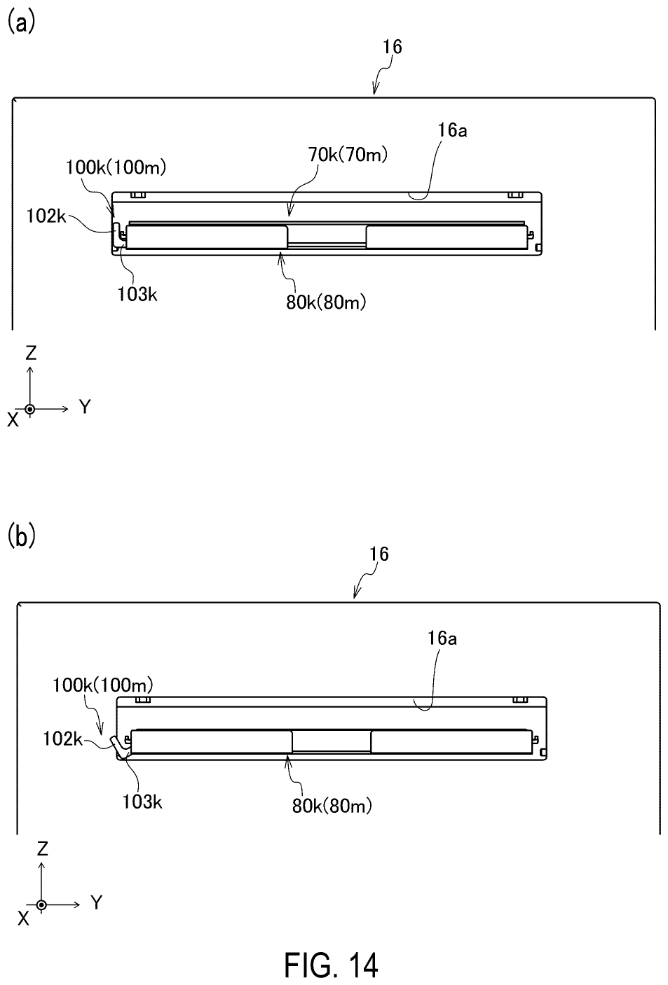

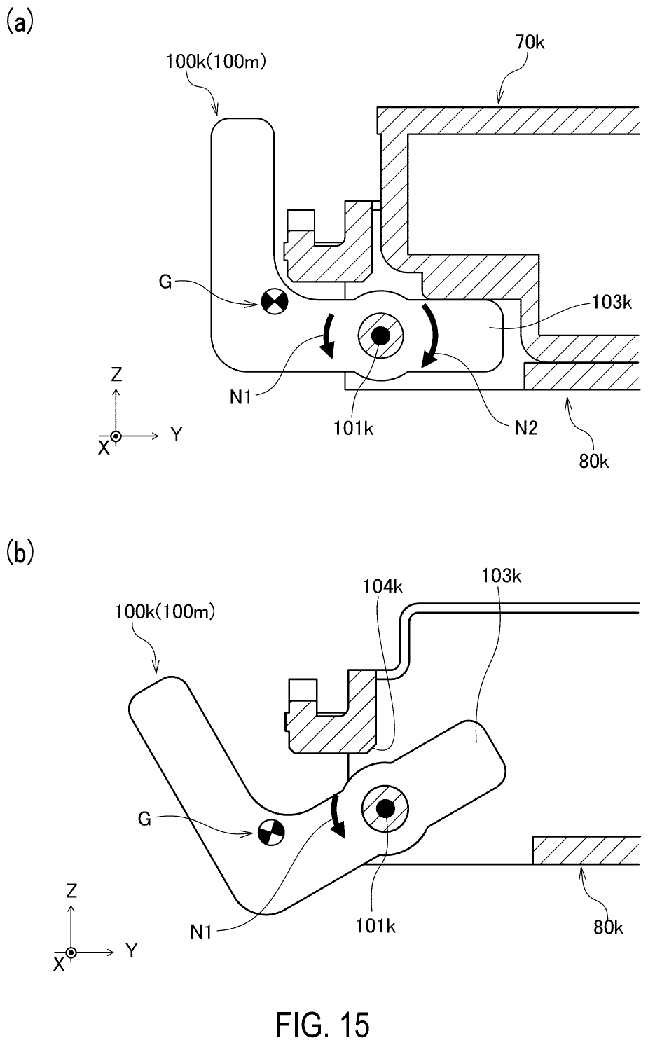

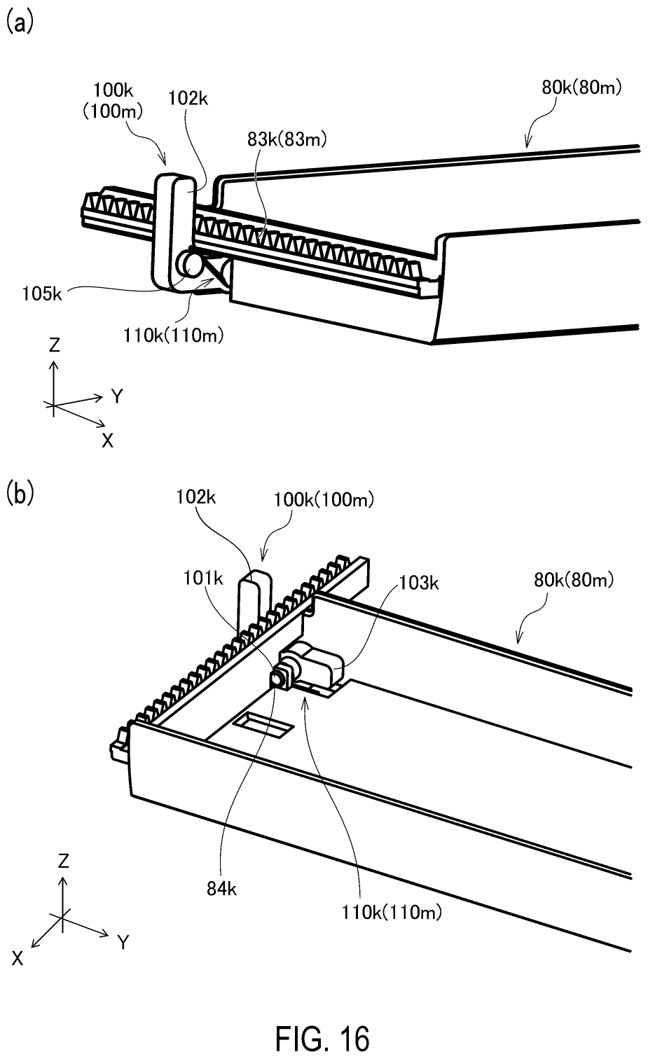

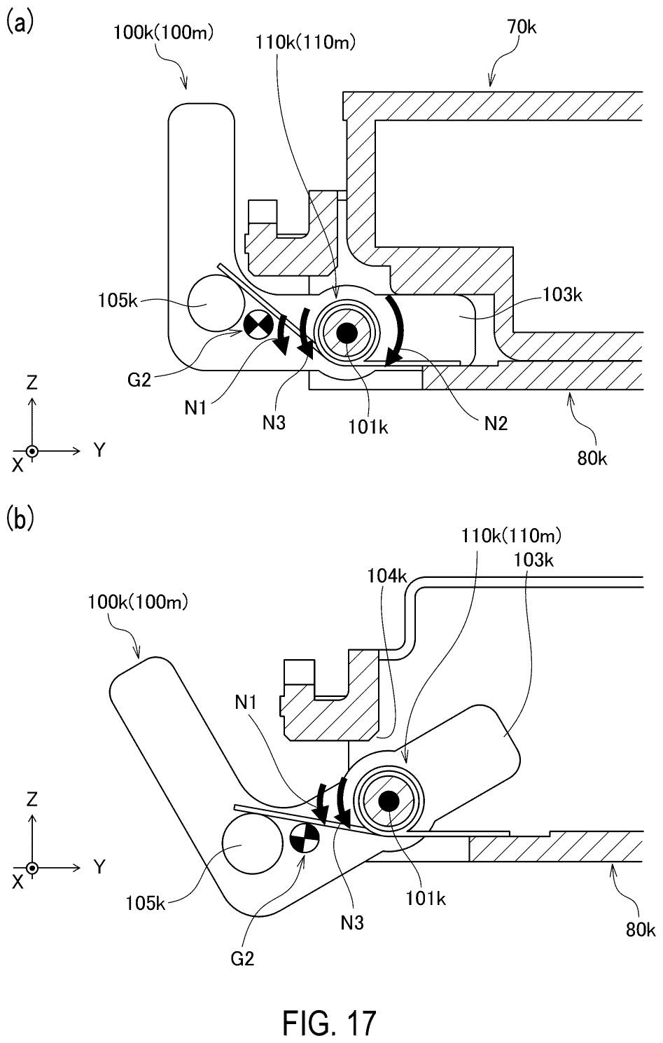

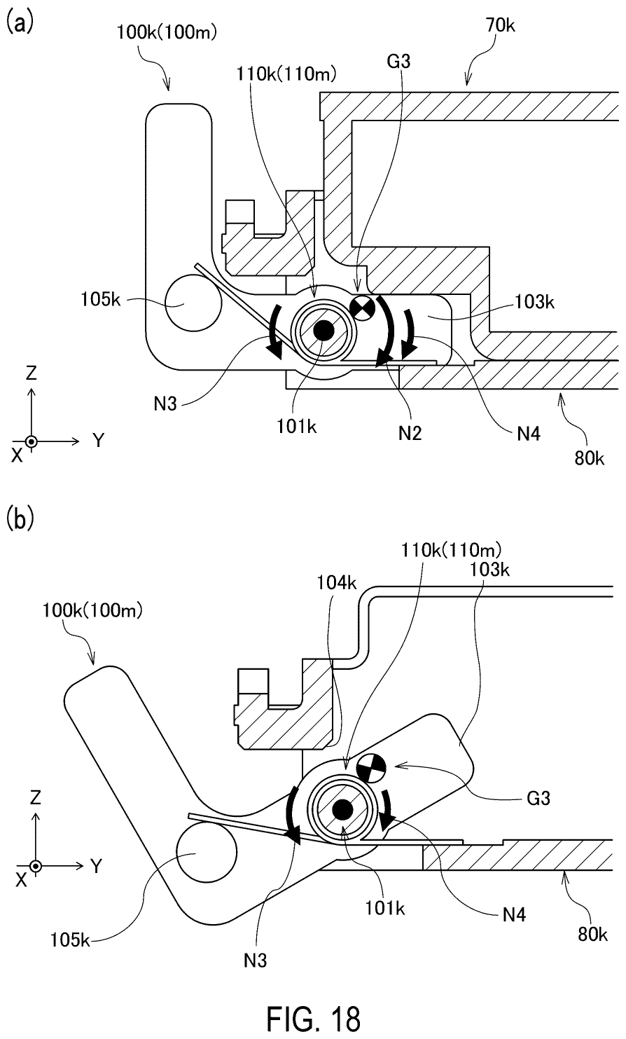

An arrangement of the trays 80y to 80k in the rotary main body 90 will be described using FIGS. 8 to 10. FIG. 8 is a perspective view showing the arrangement of the trays 80y to 80k in the rotary main body 90. FIG. 9 is a sectional view showing the arrangement of the trays 80y to 80k in the rotary main body 90. FIG. 10 is a schematic view showing an arrangement of members on one end side of the trays 80y to 80k with respect to the Y direction. Incidentally, FIG. 9 shows a cutting plane of the rotary main body 90 in a virtual flat plane perpendicular to the rotational axis 90C of the rotary main body 90. Further, an upper-half portion is the schematic view when the rotary main body 90 and the trays 80m and 80k of FIG. 8 are viewed from an upper-right side (+Z side), and a lower-half portion is the schematic view when the rotary main body 90 and the trays 80c and 80y of FIG. 8 are viewed from a left side (−X side).

As shown in FIG. 8, the trays 80y and 80k are provided with the cartridge holding portions 81y to 81k and portions-to-be-guided 82y to 82k, respectively.

To the cartridge holding portions 81y to 81k, the toner cartridges 70y to 70k are mounted, respectively. The cartridge holding portions 81y to 81k accommodate at least parts of the toner cartridges 70y to 70k, respectively.

The portions-to-be-guided 82y to 82k are provided in opposite end portions of the trays 80y to 80k sandwiching the cartridge holding portions 81y to 81k, respectively, with respect to the Y direction. Each of the portions-to-be-guided 82y to 82k is a member extended thin and long in a direction perpendicular to the rotational axis of the rotary main body 90.

In this embodiment, on a part of the portion-to-be-guided 82k with respect to a movement direction Dk of the tray 80k, a reinforcing rib 82k1 is formed, and on an part of the portion-to-be-guided 82m with respect to a movement direction Dm of the tray 80m, a reinforcing rib 82m1 is formed (see also parts (a) and (b) of FIG. 11). The reinforcing ribs 82k1 and 82m1 are projected to the outside in the Y direction from the portions-to-be-guided 82k and 82m provided in opposite end portions of the trays 80k and 80m with respect to the Y direction, and have rib shapes (protrusions) extending thin and long in the movement directions Dk and Dm of the trays 80k and 80m. By the reinforcing ribs 82k1 and 82m1, rigidity of the portions-to-be-guided 82k and 82m is improved.

Incidentally, in this embodiment, length of the reinforcing ribs 82m1 and 82k1 are restricted by avoiding the portions-to-be-guided 82y and 82c, but in the case where interference with the portions-to-be-guided 82y and 82c do not occur, the reinforcing ribs 82m1 and 82k1 may be provided over full lengths of the portions-to-be-guided 82m and 82k. On the portions-to-be-guided 82y and 82c, reinforcing ribs may be added. In the case where the rigidity of the portions-to-be-guided 82m and 82k is sufficient, a constitution in which the reinforcing ribs 82m1 and 82k1 are not provided may be employed.

On the portions-to-be-guided 82y to 82k, rack portions 83y to 83k (rack gears) are formed. Further, in the rotary main body 90, pinion gears 94y to 94k are rotatably held. The pinion gears 94y to 94k engage with the rack portions 83y to 83k, respectively.

The tray 80k is provided with one or more rack portions 83y. The rotary main body 90 is provided with one or more pinion gears 94y corresponding to the one or more rack portions 83y. Similarly, the tray 80m, the tray 80c, and the tray 80k are provided with one or more rack portions 83m, one or more rack portions 83c, and one or more rack portions 83k, respectively. The rotary main body 90 is provided with one or more pinion gears 94m, one or more pinion gears 94c, and one or more pinion gears 94k corresponding to the one or more rack portions 83m, the one or more rack portions 83c, and the one or more rack portions 83k, respectively.

The rack portions 83y to 83k and the pinion gears 94y to 94k are parts of the moving devices 85y to 85k constituted so as to move the toner cartridges 70y to 70k from the mounting positions to the retracted positions. Further, the rack portions 83y to 83k and the pinion gears 94y to 94k can be said as a part of a driven device driven by the driving device 98 of the apparatus main assembly 1. The pinion gears 94y to 94k can be said as rotatable bodies (rotatable members) for moving the trays 80y to 80k relative to the rotary main body 90 by being rotated.

The moving devices 85y to 85k and driven by the driving device 98 of the apparatus main assembly 1A. The pinion gears 94y to 94k and the rack portions 83y to 83k function as driven portions for causing the moving devices 85y to 85k to receive a driving force from the driving device 98 of the apparatus main assembly 1A. The pinion gear 94k and the rack portion 83k are examples of a first pinion gear and a first rack gear which constitute at least a part of a first driven provided to a first moving device. The pinion gear 94m and the rack portion 83m are examples of a second pinion gear and a second rack gear which constitute at least a part of a second driver portion provided to a second moving device.

The rotary main body 90 includes the guiding portions 97 engaging with the portions-to-be-guided 82y to 82k, respectively (see parts (a) and (b) of FIG. 7). In part (a) of FIG. 7, the guiding portion 97 (97k) engaging with the portion-to-be-guided 82k of the tray 80k is shown, and in part (b) of FIG. 7, the guiding portion 97 (97m) engaging with the portion-to-be-guided 82m of the tray 80m is shown. The rotary main body 90 is provided with similar guiding portions engaging with the portions-to-be-guided 82y and 82c of the trays 80y and 80c. Further, in parts (a) and (b) of FIG. 7, with respect to the Y direction, the guiding portion 97 provided on one side (+Y side) of the rotary main body 90, but a similar guiding portion 97 is also provided on the other side (−Y side) of the rotary main body 90.

When the tray 80 is moved between the accommodating position and the taking-out position, in at least a part of a movement range, the guiding portion 97 maintains a state in which the guiding portion 97 engages with the portion-to-be-guided 82 and guides the movement direction of the tray 80. In this embodiment, in a whole movement range of the tray 80k between the accommodating position and the taking-out position, the guiding portion 97 maintains the state in which the guiding portion 97 engages with the portion-to-be-guided 82k. Further, in this embodiment, in a whole movement range of the tray 80m between the accommodating position and the taking-out position, the guiding portion 97 maintains the state in which the guiding portion 97 engages with the portion-to-be-guided 82m.

Further, as shown in FIGS. 8 and 9, in the rotary main body 90, the four trays 80y to 80k are disposed on each other as described specifically in the following.

When the pinion gears 94y to 95k are rotated, the rack portions 83y to 83k and the trays 80y to 80k are moved relative to the rotary main body 90. As shown in FIG. 9, the four trays 80y to 80k are disposed so that movement directions of the trays 80y to 80k are directions each rotated by 90 degrees relative to the rotary main body 90. For that reason, each of a combination of the trays 80y and 80c and a combination of the trays 80m and 80k is slidably and movably held substantially in the same direction (parallel direction). The movement direction of each of the trays 80y to 80k during the slide movement is restricted by engagement with an associated one of the above-described portions-to-be-guided 82y to 82k.

Incidentally, the trays 80y to 80k are moved to the apparatus outside through the opening 16a. When each of the trays 80y to 80k is moved to the apparatus outside through the opening 16a, the movement direction of each tray is substantially the same direction (parallel direction).

As shown in FIG. 9, with respect to the movement direction Dk of the tray 80k, a range in which the tray 80k is disposed so as to overlap with a range in which the tray 80y is disposed and a range in which the tray 80c is disposed.

Further, with respect to the movement direction Dk of the tray 80k, the range in which the tray 80k is disposed overlaps with the rotational axis 90C of the rotary main body 90. That is, the toner cartridge 70k held by the cartridge holding portion 81k of the tray 80k can be said to overlap with the rotational axis 90C of the rotary main body 90 (part (b) of FIG. 4).

On the other hand, with respect to the movement direction Dm of the tray 80m, a range in which the tray 80m is shifted and disposed so as not to overlap with the range in which the tray 80y is disposed and the range in which the tray 80c is disposed. Further, with respect to a movement direction Dy of the tray 80y, the range in which the tray 80y is disposed is shifted and disposed so as not to overlap with the range in which the tray 80m is disposed and the range in which the tray 80k is disposed. Similarly, with respect to a movement direction Dc of the tray 80c, the range in which the tray 80c is disposed is shifted and disposed so as not to overlap with the range in which the tray 80m is disposed and the range in which the tray 80k is disposed.

A mutual positional relationship between the trays 80 can also be expressed in the following manner. As viewed in the movement direction Dy of the tray 80y, the tray 80y and the tray 80k overlap with each other, but the tray 80y and the tray 80m do not overlap with each other. As viewed in the movement direction Dm of the tray 80m, the tray 80m and the tray 80k overlap with each other, but the tray 80m and the tray 80y and 80c do not overlap with each other. As viewed in the movement direction Dc of the tray 80c, the tray 80c and the tray 80k overlap with each other, but the tray 80c and the tray 80m do not overlap with each other.

Here, overlapping of two elements (members, parts, units) as viewed in a specific direction refers to that in the case where these elements are perpendicular projected on a virtual plane perpendicular to the specific direction, a projection region of one element and a projection region of the other element at least partially overlap with each other.

As shown in FIGS. 8 and 10, with respect to the direction (Y direction) of the rotational axis 90C, a range in which the rack portion 83m and the portion-to-be-guided 82m and disposed and a range in which the rack portion 83k and the portion-to-be-guided 82k are disposed at least partially overlap with each other. That is, in this embodiment, it can be said that with respect to the rotation axis direction (Y direction) of the rotary, the range in which the first rack gear (rack portion 83k) is disposed and the range in which the second rack gear (rack portion 83m) is disposed at least partially overlap with each other. Accordingly, when compared with an arrangement such that the rack portion 83m and the portion-to-be-guided 82m do not overlap with the rack portion 83k and the portion-to-be-guided 82k, with respect to the Y direction, the rack portions 83m and 83k and the portions-to-be-guided 82m and 82k can be disposed in a space-saving manner.

With respect to the direction (Y direction) of the rotational axis 90C, a range in which the rack portion 83y and the portion-to-be-guided 82y and disposed and a range in which the rack portion 83c and the portion-to-be-guided 82c are disposed at least partially overlap with each other. That is, in this embodiment, with respect to the rotation axis direction (Y direction) of the rotary, the range in which the third rack gear (rack portion 83y) is disposed and the range in which the fourth rack gear (rack portion 83c) is disposed at least partially overlap with each other. Accordingly, when compared with an arrangement such that the rack portion 83y and the portion-to-be-guided 82y do not overlap with the rack portion 83c and the portion-to-be-guided 82c, with respect to the Y direction, the rack portions 83y and 83c and the portions-to-be-guided 82y and 82c can be disposed in a space-saving manner.

Here, an engaging position between the rack portion (rack gear) 83 and the pinion gear 94 will be described using FIG. 10. An upper-half portion of FIG. 10 shows the engaging position between the rack portion 83k and the pinion gear 94k. A lower-half portion of FIG. 10 shows the engaging position between the rack portion 83y and the pinion gear 94y.

With respect to the direction (Y direction) of the rotational axis 90C of the rotary main body 90, in a region Y1 in FIG. 10, a driving force transmitted by a transmitting device described later from the motor M2 (FIG. 2) as the driving source. With respect to the Y direction, in a region Y2 in FIG. 10, the pinion gear 94k engages with the rack portion 83k so that the drive can be transmitted. Further, with respect to the Y direction, in a region Y3 in FIG. 10, the pinion gear 90y engages with the rack portion 83y so that the drive can be transmitted. Incidentally, the rack portion 83m engages with the pinion gear 94m (FIG. 8) so that the drive can be transmitted in the region Y2 similarly s in the case of the rack portion 83k. The rack portion 83c engages with the pinion gear 94c (FIG. 8) so that the drive can be transmitted in the region Y3 similarly as in the case of the rack portion 83y.

Here, the region Y2 and the region Y3 are in different positions with respect to the Y direction (are shifted in the Y direction). Further, the region Y1 is in position different from the region Y2 and the region Y3. That is, the region Y1 is shifted from the region Y2 and the region Y3 in the Y direction. Further, in a state in which the toner cartridges 70y and 70c are in the mounting positions, with respect to the movement direction (movement direction Dy of the tray 80y) of the rack portion 83y, the range in which the rack portion 83y is disposed and the range in which the rack portion 83c is disposed at least partially overlap with each other. In this embodiment, the movement directions Dy and Dc of the trays 80y and 80c are substantially the same direction (parallel directions), and therefore, also, with respect to the movement direction Dc of the tray 80c, the range in which the rack portion 83y is disposed the range in which the rack portion 83c is disposed at least partially overlap with each other. Accordingly, in the state in which the toner cartridges 70y and 70c are in the mounting positions, with respect to a direction (left-right direction of FIG. 8) perpendicular to the movement directions Dy and Dc of the rack portions 83y and 83c, a tooth surface of the rack portion 83y and a tooth surface of the rack portion 83c oppose each other.

Further, in a state in which the toner cartridges 70m and 70k are in the mounting positions, with respect to the movement direction (movement direction Dm of the tray 80m) of the rack portion 83m, the range in which the rack portion 83m is disposed and the range in which the rack portion 83k is disposed at least partially overlap with each other. In this embodiment, the movement directions Dm and Dk of the trays 80m and 80k are substantially the same direction (parallel directions), and therefore, also, with respect to the movement direction Dk of the tray 80k, the range in which the rack portion 83m is disposed the range in which the rack portion 83k is disposed at least partially overlap with each other. Accordingly, in the state in which the toner cartridges 70m and 70k are in the mounting positions, with respect to a direction (up-down direction of FIG. 8) perpendicular to the movement directions Dm and Dk of the rack portions 83m and 83k, a tooth surface of the rack portion 83m and a tooth surface of the rack portion 83k oppose each other.

Further, as also shown in part (a) of FIG. 12 described later, as viewed in the direction (Y direction) of the rotational axis 90C, the rack portion 83y overlaps with the rack portion 83m and the rack portion 83k. As viewed in the direction (Y direction) of the rotational axis 90C, the rack portion 83m overlaps with the rack portion 83y and the rack portion 83c. As viewed in the direction (Y direction) of the rotational axis 90C, the rack portion 83c overlaps with the rack portion 83m and the rack portion 83k. As viewed in the direction (Y direction) of the rotational axis 90C, the rack portion 83k overlaps with the rack portion 83y and the rack portion 83c. In other words, with respect to the rotation axis direction (Y direction) of the rotary, it can be said that the range in which the first rack gear (rack portion 83k) is disposed and the range in which the second rack gear (rack portion 83y) is disposed do not overlap with each other. Further, as viewed in the rotation axis direction (Y direction) of the rotary, it can be said that the first rack gear (rack portion 83k) and the second rack gear (rack portion 83y) overlap with each other in a state in which the first toner cartridge 70k is in the first mounting position and the second toner cartridge 70y is in the second mounting position.

Thus, with respect to the Y direction, a position where the rack portions 83k and 83m are disposed and a position where the rack portions 83y and 83c are disposed are different from each other, and therefore, it is possible the make the arrangement so that as viewed in the Y direction, the rack portions 83y and 83c and the rack portions 83m and 83k overlap with each other.

By this, space saving of the arrangement of the four trays in the rotary main body 90 is carried out, so that downsizing of the rotary main body 90 with respect to the rotation radius direction can be realized. That is, when the rack portions 83 are intended to be disposed so as not to overlap with each other as viewed in the Y direction while making the movement distances of the trays 80y to 80k the same as those in this embodiment, as viewed in the Y direction, an area necessary to arrange the four rack portions becomes large. Compared with such a constitution, the plurality of rack portions 83 are disposed while being shifted in position in the Y direction, and the rack portions 83 are caused to overlap with each other as viewed in the Y direction, so that as viewed in the Y direction, an arrangement area of the rack portions 83 can be made small.

Further, in this embodiment, the four rack portions 83y to 83k are divided into two sets each including two rack portions and are disposed while being shifted in position in the Y direction. That is, with respect to the rotation axis direction (Y direction) of the rotary, it can be said that a range in which a first rack gear is disposed and a range in which a second rack gear is disposed overlap with each other and that a range in which a third rack gear is disposed and a range in which a fourth rack gear is disposed overlap with each other. Further, with respect to the Y direction, it can be said that a range in which the first rack gear and the second rack gear are disposed and a range in which the third rack gear and the fourth rack gear are disposed do not overlap with each other. By this, compared with the case where the four rack portions 83y to 83k are shifted in position in the Y direction, it is possible to downsize the rotary main body 90 with respect to the Y direction.

### (Tray Movement Constitution)

A constitution relating to movement of the trays 80y to 80k disposed in the rotary main body 90 using parts (a) and (b) of FIG. 11 and parts (a) and (b) of FIG. 12. Parts (a) and (b) of FIG. 11 are perspective views showing a constitution relating to movement of the tray 80k. Parts (a) and (b) of FIG. 12 are sectional views showing the constitution relating to the movement of the tray 80k.

In this embodiment, each of the trays 80y to 80k is driven by transmitting the driving force of the motor M2 to an associated one of the pinion gears 94y to 94k by the driving racks 15L and 15R as the transmitting device. Here, a constitution in which the tray 80k is moved relative to the rotary main body 90 is described, and a constitution in which the trays 80y to 80c are moved relative to the rotary main body 90 is substantially similar to the constitution in which the tray 80k is moved, and therefore will be omitted from description.

Part (a) of FIG. 11 shows a state in which the tray 80k is positioned inside the rotary main body 90 (i.e., a state in which the toner cartridge 70k is mounted to the developing unit 50k). That is, part (a) of FIG. 11 shows a state in which the tray 80k is in the accommodating position and corresponds to a state in which the toner cartridge 70k is in the mounting position relative to the developing frame 53k (part (a) of FIG. 4). Part (b) of FIG. 11 shows a state in which the tray 80k is slid and moved to the outside of the rotary main body 90. That is, part (b) of FIG. 11 shows a state in which the tray 80k is in the taking-out position and corresponds to a state in which the toner cartridge 70k is in the retracted position relative to the developing frame 53k (part (a) of FIG. 4).

The apparatus main assembly 1A in this embodiment includes the driving racks 151L and 151R as the driving gears for driving the pinion gears 94. Each of the driving racks 15 is driven by the motor M2 through the transmitting portion 15t. As shown in part (a) of FIG. 11, in a state in which the tray 80k is in the rotary main body 90 (that is, in a state in which the toner cartridge 70k is mounted to the developing unit 50k), the driving racks 15L and 15R are in non-engaging positions way from the pinion gears 94k. The driving racks 15L and 15R are moved from the non-engaging positions and are engaged with the pinion gears so that the tray 80k is moved from the accommodating position to the taking-out position and so that the toner cartridge 70k is moved from the mounting position to the retracted position.

As described above, two rack portions 83k are formed in an opposite end portions of the tray 80k with respect to the Y direction. The two pinion gears 94k and the (two) driving racks 15L and 15R are disposed in positions each corresponding to the associated rack portion 83k in the associated one of the opposite end portions. That is, the apparatus main assembly 1A in this embodiment includes the driving racks 15L and 15R as a first driving gear and a second driving gear. It can be said that the driving rack 15L is an example of the first driving gear, and the driving rack 15R is an example of the second driving gear.

However, numbering of these racks is merely used for convenience of explanation, and can be appropriately replaced in principle. In the case where there is no need to distinguish the driving racks 15L and 15R, these racks are represented by the “driving rack(s) 15”.

The rack portions 83 in this embodiment are constituted as a rack gear pair, and the pinion gears 94 in this embodiment are constituted as a pinion gear pair. Each of the rack gear pair and the pinion gear pair is disposed on one end side and on the other end side of the supporting member (tray 80) with respect to the Y direction in this embodiment, but may also be disposed in other positions. It can be said that the rack portions 83k and the pinion gears 94k of the moving devices 85k corresponding to the tray 80k are examples of a first rack gear pair and a first pinion gear pair, respectively.

Each of the rack portions 83y to 83c and the pinion gears 94y to 94c of the moving devices 85y to 85c corresponding to other trays 80y to 80c, respectively, are examples of a second rack gear pair and a second pinion gear pair, respectively.

One of the rack gear pair engages with each of the pinion gear pair, and the other one of the rack gear pair engages with the other one of the pinion gear pair. At least one of the pinion gear pair is driven by the driving rack 15L as the first driving rack. In this embodiment, both gears of the pinion gear pair are simultaneously driven by the driving racks 15L and 15R as the first driving rack and the second driving rack. By this, rotation of the tray 80 does not readily occur, so that stable movement of the toner cartridge 70 becomes possible.

Incidentally, a constitution in which the tray 80 includes the rack portion 83 and is moved by a single driving rack 15 through a single pinion gear 94.

The tray 80k is held slidably and movably in a direction parallel to the portion-to-be-guided 82k (i.e., the movement direction Dk) relative to the rotary main body 90. The driving rack 15 is held slidably and movably in a direction crossing the movement direction Dk of the tray 80k relative to the apparatus main assembly 1A. The driving rack 15 is constituted so as to be slid and moved (reciprocated) relative to the apparatus main assembly 1A in a first direction (upward vertical direction in this embodiment) and a second direction (downward vertical direction in this embodiment) opposite to the first direction. That is, a movement direction of the driving rack in this embodiment is a direction crossing (preferably perpendicular to) both of the movement direction of the tray 80k and the direction (Y direction) of the rotational axis 90C of the rotary main body 90.

A tray moving operation for sliding and moving the tray 80k between the accommodating position and the taking-out position will be described using parts (a) and (b) of FIG. 11. The tray moving operation of the tray 80k is performed by the motor M2 (FIG. 2), the transmitting portion 15t, the driving racks 15, the pinion gears 94k, and the rack portions 83k.

First, the tray moving operation (tray pulling-out operation) when the toner cartridge 70k is demounted (removed) from the rotary main body 90 will be described. In a state before the tray pulling-out operation is started, the driving racks 15 are positioned below positions where the driving racks 15 engage with the pinion gears 94k (part (a) of FIG. 11). Further, as described above, in the exchanging operation of the toner cartridge 70k, the rotary main body 90 takes the exchange attitude of the toner cartridge 70k (part (b) of FIG. 4).

When the tray pulling-out operation is started, by the driving force of the motor M2, the driving racks 15 are slid and moved in an upward direction of the image forming apparatus 1A. In a process in which the driving racks 15 are moved, the driving racks 15 engage with the pinion gears 94k, so that the pinion gears 94k are rotationally driven.

As shown in part (b) of FIG. 11, the pinion gears 94k are rotationally driven in arrow directions in part (b) of FIG. 11, so that the driving force is inputted to the rack portions 83k engaging with the pinion gears 94k. By this, the tray 80k is pushed out to the apparatus outside and is moved relative to the rotary main body 90 from the accommodating position to the retracted position. The movement direction of the tray 80k at this time is guided to a predetermined movement direction Dk by engagement of the portions-to-be-guided 82k with the guiding portions 87k (part (a) of FIG. 7) of the rotary main body 90. As a result that the tray 80k is moved from the accommodating position to the taking-out position, the toner cartridge 70k is moved from the mounting position to the retracted position relative to the developing unit 50k.

In a state in which the tray 80k is positioned in the taking-out position and the toner cartridge 70k is positioned in the retracted position, the user is capable of performing mounting and demounting of the toner cartridge 70k relative to the tray 80k.

A tray moving operation (tray drawing-in operation, tray inserting operation) when the toner cartridge 70 is mounted to the rotary main body 90 is performed in a process reverse to the process of the tray pulling-out operation. For example, the user operates a predetermined operating portion, so that the tray drawing in operation is started. When the tray drawing in operation is started, by the pinion gear force of the motor M2, the driving racks 15 are slid and moved in a downward direction of the apparatus main assembly 1A. Here, a rotational direction of the motor M2 in the tray drawing-in operation is a direction opposite to the rotational direction of the motor M2 in the tray pulling-out operation.

The pinion gears 94k are rotationally driven in directions opposite to the arrow directions of part (b) of FIG. 11, so that the driving force is inputted to the rack portions 83k engaging with the pinion gears 94k. By this, the tray 80k is drawn into an apparatus inside and is moved from the taking-out position to the accommodating position relative to the rotary main body 90.

The movement direction of the tray 80k is guided to a direction (opposite direction to the arrow of the movement direction Dk (part (b) of FIG. 11) by engagement of the portions-to-be-guided 82k with the guiding portions 97k (part (a) of FIG. 7) of the rotary main body 90. As a result that the toner cartridge 70k is moved from the taking-out position to the accommodating position, the toner cartridge 70k is moved from the retracted position to the mounting position relative to the developing unit 50k.

As described above, the movement of the tray 80k for black and the toner cartridge 70k for black was described, but movement of other trays 80y to 80c and other toner cartridges 70y to 70c is performed by similar mechanisms. That is, in each of exchange attitudes of the toner cartridges, the driving racks 15 transmit drive of the pinion gears 94y to 94c.

By the motor M2 provided in the apparatus main assembly 1A and the transmitting device including the driving racks 15 (15L, 15R) and the transmitting portion 15t, the driving device 98 for driving the moving device 85 provided to the rotary main body 90 is constituted.

As described above, in this embodiment, in the rotary main body 90, a plurality of moving devices 85y to 85k corresponding to a plurality of toner cartridges 70y to 70k are disposed. The driving device 98 of the apparatus main assembly 1A is a common driving device for driving the plurality of moving devices 85y to 85k (plurality of driven devices) of the rotary main body 90.

Further, in this embodiment, by the rotation of the rotary main body 90, a driving object of the driving device 98 is switched. In other words, the driving device in this embodiment includes the driving rack 15 as a transmitting member for transmitting the driving force of the driving source. The driving device is capable of taking a state in which the transmitting member engages with a first driven portion (pinion gear 94k) so that the drive can be transmitted and a state in which the transmitting member engages with a second driven portion (pinion gear 94m) so that the drive can be transmitted. Further, the driving device is capable of taking a state in which the transmitting member is separated (disengaged) from the first driven portion and the second driven portion.

As described above, the pinion gears 94y to 94k are held by the rotary main body 90. Accordingly, when the rotary main body 90 is rotated, it is preferable that the engagement of the pinion gears 94y to 94k with the driving racks 15 is released.

Part (a) of FIG. 12 shows a state in which the tray 80k is positioned inside the rotary main body 90 (state in which the tray 80k is in the accommodating position). Part (b) of FIG. 12 shows a state in which the tray 80k is moved to the outside of the rotary main body 90 (state in which the tray 80k is moved to the taking-out position).

As shown in part (a) of FIG. 12, when the tray 80k is positioned inside the rotary main body 90, the driving rack 15 is positioned at a lower portion in the apparatus main assembly 1A. At this time, the driving rack 15 is retracted from the pinion gear 94k. For that reason, the driving rack 15 does not hinder the rotation of the rotary main body 90, so that the rotary main body 90 can be rotated. Specifically, the driving rack 15 can be retracted to an outside of a rotation locus of the rotary main body 90 indicated by a broken line in each of parts (a) and (b) of FIG. 12.

As described above, by rotationally driving the motor M2 in a normal direction and a reverse direction, the tray 80 mounted to the rotary main body 90 can be moved relative to the rotary main body 90 from the accommodating position to the taking-out position and from the taking-out position to the accommodating position. That is, the driving device in this embodiment is capable of driving each of the moving devices of the rotary so that the toner cartridge is moved not only from the mounting position to the retracted position but also from the retracted position to the mounting position.

Here, as described above, in this embodiment, corresponding to a size of the toner cartridge 70, a movement amount of the tray 80 during the exchange of the toner cartridge 70 is changed. Specifically, as shown in parts (a) and (b) of FIG. 7, the movement distance L1 when the tray 80 for black is moved from the accommodating position to the taking-out position is longer than the movement distance L2 when each of the trays 80y to 80c is moved from the accommodating position to the taking-out position.

For that reason, in this embodiment, when each of the toner cartridges 70y to 70k is moved from the mounting position to the retracted position, a value obtained by dividing a speed of the rack portion 83k by a speed of the driving rack 15 is higher than a value obtained by dividing a speed of each of the rack potions 83y to 83c by a speed of the driving rack 15.

For example, as shown in FIG. 10, the pinion gear 94y is made a stepped gear, and a pitch circle radius of a small-diameter gear 942 engaging with the rack portion 83y is made smaller than a pitch circle radius of a large-diameter gear 941 engaging with the driving rack 15. Also, the pinion gears 94m and 94c are made similar stepped gears. On the other hand, the pinion gear 94k has the same pitch circle radius between a portion thereof engaging with the driving rack 15 and a portion thereof engaging with the rack portion 83k. At this time, the pitch circle radius can be made the same pitch circle radius as the large-diameter gear 941 of each of the pinion gears 94y to 94c. According to this constitution, even when the movement distances of the driving racks 15 are the same, the movement distance of the rack portion 83k can be made longer than the movement distance of each of other rack portions 83y to 83c. That is, the movement distance L1 when the tray 80k for black is moved from the accommodating position to the taking-out position can be made longer than the movement distance L2 when each of other trays 80y to 80c is moved from the accommodating position to the taking-out position.

Further, by making the pinion gears 94y to 94c the stepped gears, while employing a constitution in which the pinion gears 94y to 94k receive the driving force from the same driving gear, the movement distance L1 of the tray 80k can be made longer that the movement distance L2 of each of other trays 80y to 80c.

Incidentally, instead of (or in combination with) the constitution in which the pinion gears 94y to 94c are made the stopped gears, the pinion gear 94k may be made the stopped gear. In this case, it may only be required that a portion of the pinion gear 94k engaging with the driving rack 15 is made a small-diameter gear and a portion of the pinion gear 94k engaging with the rack portion 83k is made a large-diameter gear having a pitch circle radius larger than a pitch circle radius of the small-diameter gear. Further, the stepped gear is an example of a speed reducing mechanism and may be replaced by a known speed reducing mechanism for making a movement amount of an input-side (driving source-side) member smaller than a movement amount of an output-side (tray 80-side) member.

Further, a movement amount of the driving rack 15 when the toner cartridge 70k is moved from the mounting position to the retracted position may be made larger than a movement amount of the driving rack 15 when each of the toner cartridges 70y to 70c is moved from the mounting position to the retracted position.

Incidentally, when a distance of movement of the toner cartridge 70 from the mounting position to the retracted position is short, a moving time of the toner cartridge 70 can be made short, so that a time in which the user waits for the movement of the toner cartridge can be made short. As described above, when a constitution in which the movement amount of the driving rack 15 for the toner cartridge 70k is larger than the movement amount of the driving rack 15 for the toner cartridges 70y to 70c is employed, the time in which the user waits for the movement of the toner cartridges 70y to 70c can be made short.

By the above-described constitutions, the movement distance L1 can be made longer than the movement distance L2. These constitutions can be used in combination.

Incidentally, in the above-described constitution, a constitution in which the driven portion includes the pinion gear 94 engaging with both the driving rack 15 and the rack portion 83 was described, but the driven portion may include a gear engaging with the driving rack 15 and a gear engaging with the rack portion 83.

Further, a constitution of the moving device 85 for moving the tray 80 is not limited to a so-called rack-and-pinion constitution. For example, a member corresponding to the pinion gear 94 is replaced by a roller rotated by receiving the drive of the motor M2, and the tray 80 may be moved by friction between the roller and the tray 80.

Further, in the case where the roller rotated by receiving the drive of the motor M2 is used, the roller and the toner cartridge 70 may be made in contact with each other. In this case, the toner cartridges 70y to 70k can also be made detachably mountable to the rotary main body 90 directly without through the trays 80y to 80k, respectively. In this case, the moving device 85 is constituted by the roller.

### (Swing Arm)

Next, a swing arm 100k for preventing forgetting of mounting of the toner cartridge 70k to the tray 80k will be described using part (a) of FIG. 13 to part (b) of FIG. 15. Incidentally, in the following, the swing arm 100k mounted to the tray 80k will be described, but also to the trays 80y to 80c, swing arms having similar constitutions and functions are mounted. Description of the swing arms mounted to these trays 80y to 80c will be appropriately omitted.

Parts (a) and (b) of FIG. 13 are perspective views showing the swing arm 100k and the tray 80k. Parts (a) and (b) of FIG. 14 are front views showing the opening 16a of the frame 16 and the swing arm 100k. Parts (a) and (b) of FIG. 15 are sectional views showing an operation of the swing arm 100k. As shown in parts (a) and (b) of FIG. 13, to the tray 80k, the swing arm 100k swingably supported about a swing shaft 101k is mounted. The tray 80k is provided with a hole 84k, and the swing shaft 101k extending in the X direction engages with the hole 84k. For this reason, the swing arm 100k moves integrally with the tray 80k when the tray 80k is moved between the taking-out position and the accommodating position.

The swing arm 100k includes a contact portion 102k positioned on one side of the swing shaft 101k and a portion-to-be-pressed 103k positioned on the other side of the swing shaft 101k. The contact portion 102k is positioned upstream of the tray 80k with respect to the Y direction, and the portion-to-be-pressed 103k projects into a mounting region of the toner cartridge 70k in the tray 80k.

The swing arm 100k is disposed on the −X side than a center 80kc of the tray 80k with respect to the X direction. In other words, the swing arm 100k as a first moving member and a moving member is disposed on a side downstream of the center 80kc of the tray 80k with respect to a movement direction (−X direction) when the tray 80k is moved from the taking-out position to the accommodating position. As described above, the swing arm is also mounted to the trays 80y to 80k. A swing arm 100m as a second moving member mounted to the tray 80m is also disposed on a side downstream of a center 80mc of the tray 80m with respect to the movement direction (−X direction) when the tray 80m is moved from the taking-out position to the accommodating position.

The swing arm 100k is constituted so as to be swingable between a first position shown in part (a) of FIG. 14 and a second position shown in part (a) of FIG. 14. In other words, the swing arm 100k is constituted so as to be rotatable about the swing shaft 101k as a first rotation shaft between the first position and the second position. The portion-to-be-pressed 103k of the swing arm 100k is pressed downward by the toner cartridge 70k by mounting the toner cartridge 70k to the tray 80k as shown in part (a) of FIG. 14. By this, the swing arm 100k is held in the first position.

On the other hand, as shown in part (b) of FIG. 14, when the toner cartridge 70k is demounted from the tray 80k, the swing arm 100k is swung in the counterclockwise direction of parts (a) and (b) of FIG. 14 and thus is moved from the first position to the second position. Then, the portion-to-be-pressed 103k of the swing arm 100k abuts against a stopper portion 104k of the tray 80k shown in part (b) of FIG. 13, so that the swing arm 100k is held in the second position.

In the first position shown in part (a) of FIG. 14, as viewed in the −X direction, a whole of the swing arm 100k is positioned inside the opening 16a of the frame 16. That is, in a state in which the swing arm 100k is positioned in the first position and the tray 80k is positioned in the taking-out position, the contact portion 102k and the portion-to-be-pressed 103k of the swing arm 100k are positioned inside the opening 16a as viewed in the −X direction. Further, in a state in which the tray 80k is in the taking-out position, in the second position shown in part (b) of FIG. 14, at least a part of the swing arm 100k projects to an outside of the opening 16a as viewed in the −X direction. Specifically, in a state in which the swing arm 100k is positioned in the second position and the tray 80k is positioned in the taking-out position, at least a part of the contact portion 102k projects to the outside of the opening 16a as viewed in the −X direction.

The above-described constitution of the swing arm 100k is also similar that the swing arm 100m. That is, when the toner cartridge 70m is demounted from the tray 80m, the swing arm 100m is moved from the third position shown in part (a) of FIG. 14 to the fourth position shown in part (a) of FIG. 14. The swing arm 100m is constituted so as to be rotatable about a swing shaft 101m as a second rotation shaft between the third position and the fourth position. In the third position shown in part (a) of FIG. 14, as viewed in the −X direction, a whole of the swing arm 100m is positioned inside the opening 16a of the frame 16. Further, in a state in which the tray 80m is positioned in the taking-out position, in the fourth position shown in part (b) of FIG. 14, at least a part of the swing arm 100m projects to the outside of the opening 16a as viewed in the −X direction.

For example, the case where the toner cartridge 70k is demounted from the tray 80k by moving the tray 80k to the taking-out position by the user and then the tray 80k is moved from the taking-out position to the accommodating position without mounting a new toner cartridge 70k will be considered. At this time, the swing arm 100k is held in the second position because the toner cartridge 70k is not mounted to the tray 80k. Then, when the tray 80k is moved toward the accommodating position in the X direction as it is, the swing arm 100k positioned in the second position abuts against the frame 16. By this, movement of the tray 80k from the taking-out position to the accommodating position is restricted. In other words, when the swing arm 100k is positioned in the second position, the swing arm 100k restricts the movement of the tray 80k from the taking-out position to the accommodating position.

On the other hand, the case where the tray 80k is moved from the taking-out position to the accommodating position in a state in which the toner cartridge 70k is mounted to the tray 80k will be considered. At this time, the swing arm 100k is held in the first position because the toner cartridge 70k is mounted to the tray 80k. Then, when the tray 80k is moved toward the accommodating position in the X direction as it is, the swing arm 100k positioned in the first position does not interfere with the frame 16, so that the movement of the tray 80k from the taking-out position to the accommodating position is permitted through the opening 16a. In other words, when the swing arm 100k is positioned in the first position, the swing arm 100k permits the movement of the tray 80k from the taking-out position to the accommodating position.

Similarly, the case where the toner cartridge 70m is demounted from the tray 80m by moving the tray 80m to the taking-out position by the user and then the tray 80m is moved from the taking-out position to the accommodating position without mounting a new toner cartridge 70m will be considered. At this time, the swing arm 100m is held in the fourth position because the toner cartridge 70m is not mounted to the tray 80m. Then, when the tray 80m is moved toward the accommodating position in the X direction as it is, the swing arm 100m positioned in the second position abuts against the frame 16. By this, movement of the tray 80m from the taking-out position to the accommodating position is restricted.

On the other hand, the case where the tray 80m is moved from the taking-out position to the accommodating position in a state in which the toner cartridge 70m is mounted to the tray 80m will be considered. At this time, the swing arm 100m is held in the third position because the toner cartridge 70m is mounted to the tray 80m. Then, when the tray 80m is moved toward the accommodating position in the X direction as it is, the swing arm 100m positioned in the third position does not interfere with the frame 16, so that the movement of the tray 80m from the taking-out position to the accommodating position is permitted through the opening 16a.

Next, an operation principle of the swing arm 80k will be described using parts (a) and (b) of FIG. 15.

In part (a) of FIG. 15, the toner cartridge 70k is mounted to the tray 80k, and the swing arm 100k is positioned in the first position. In part (b) of FIG. 15, the toner cartridge 70k is demounted from the tray 80k, and the swing arm 100k is swung toward the second position.

At this time, a center of gravity of the swing arm 100k is illustrated as a center of gravity G.

As shown in part (a) of FIG. 15, in a state in which the swing arm 100k is positioned in the first position, on the swing arm 100k, moment N1 and moment N2 act around the swing shaft 101k. The moment N1 is moment by a self-weight of the swing arm 100k with the swing shaft 101k as a center, and the moment N2 is moment acting on the swing arm 100k by pressing of the portion-to-be-pressed 103k of the swing arm 100k by the toner cartridge 70k.

The center of gravity G of the swing arm 100k is positioned on a side opposite from the portion-to-be-pressed 103k while sandwiching the swing shaft 101k therebetween, and therefore, the moment N1 and the moment N2 are directed opposite to each other. That is, the center of gravity G of the swing arm 100k is positioned so that the swing arm 100k is urged from the first position toward the second position by the self-weight thereof. At this time, the moment N2 and the moment N1 balance each other, so that the swing shaft 101k is held in the first position without being swung from the first position to the second position. Incidentally, the center of gravity G of the swing arm 100m is positioned so that the swing arm 100m is urged from the third position toward the fourth position by a self-weight thereof.

As shown in part (b) of FIG. 15, when the toner cartridge 70k is demounted from the tray 80k, on the swing arm 100k, only the moment N1 by the self-weight of the swing arm 100k acts around the swing shaft 101k. By this, the swing arm 100k is swung from the first position toward the second position. When the portion-to-be-pressed 103k of the swing arm 100k abuts against the stopper portion 104k of the tray 80k, the moment N1 and moment due to that the stopper portion 104k presses the portion-to-be-pressed 103k balance each other, so that the swing arm 100k is held in the second position.

As described above, in this embodiment, a constitution in which the swing arm 100k is swung between the first position and the second position depending on mounting and demounting of the toner cartridge 70k relative to the tray 80k is employed.

Further, when the tray 80k is intended to be moved from the taking-out position to the accommodating position in a state in which the user forget the mounting of the toner cartridge 70k to the tray 80k, the swing arm 100k positioned in the second position abuts against the frame 16. By this, movement of the tray 80k from the taking-out position toward the accommodating position is restricted, and therefore the user is capable of recognizing forgetting of the mounting of the toner cartridge 70k to the tray 80k, so that usability can be improved. Further, the forgetting of the mounting of the toner cartridge 70k to the tray 80k can be suppressed.

Further, in a state in which the toner cartridge 70k is not mounted to the tray 80k, the tray 80k cannot be moved to the accommodating position, so that the door 14 cannot be moved to the closed position. For this reason, the image forming apparatus 1 cannot start the image forming operation, so that it is possible to reliably prompt the user to mount the toner cartridge 70k to the tray 80k. Incidentally, a constitution in which a sensor for detecting that the door 14 is positioned in the closed position is provided and in which the sensor detects that the door 14 is positioned in the closed position and thus the image forming operation of the image forming apparatus 1 is permitted may be employed.

Further, in this embodiment, the swing arm 100k is positioned on the −X side than the center 80kc of the tray 80k with respect to the X direction. For this reason, when the tray 80k is moved from the taking-out position toward the accommodating position in a state in which the swing arm 100k is positioned in the second position, the swing arm 100k quickly abuts against the frame 16. Therefore, it is possible to quickly recognize that the toner cartridge 70k is not mounted to the tray 80k, so that usability can be improved. Incidentally, although the swing arm 100k may be provided on the +X side than the center 80kc of the tray 80k with respect to the X direction, the swing arm 100k may preferably be provided in an end portion of the tray 80k on the −X side.

### Embodiment 2

Next, an image forming apparatus according to an embodiment 2 will be described, but the embodiment 2 is constituted by changing the position of the center of gravity G of the swing arm 100k in the embodiment 1, and in addition, by adding an urging member 110k. For this reason, constitutions similar to those in the embodiment 1 will be omitted from illustration or will be described by adding the same reference numerals or symbols to the drawings. Parts (a) and (b) of FIG. 16 are perspective views showing the swing arm 100k and the tray 80k in the embodiment 2. Parts (a) and (b) of FIG. 17 are sectional views showing an operation of the swing arm 100k.

Incidentally, in the following, the swing arm 100k mounted to the tray 80k and the urging member 110k will be described, but swing arms and urging members having similar constitutions and functions are mounted to the trays 80y to 80c. Description of the swing arms and the urging members mounted to these trays 80y and 80c will be appropriately omitted.

As shown in parts (a) and (b) of FIG. 16, to the tray 80k, the swing arm 100k supported swingably about the swing shaft 101k is mounted, and in the neighborhood of the swing arm 100k, the urging member 110k is provided. The urging member 110k in this embodiment is constituted by a torsion coil spring, and a coil portion of the urging member 110k is mounted around the swing shaft 101k. Further, one end of the urging member 110k is locked by the tray 80k, and the other end of the urging member 110k is locked by a locking rib 105k of the swing arm 100k. The swing arm 100k is urged from the first position toward the second position by the urging member 110k. Similarly, in the neighborhood of the swing arm 100m, an urging member 110m is provided, and the swing arm 100m is urged from the third position toward the fourth position by the urging member 110m.

Next, an operation principle of the swing arm 80k will be described using parts (a) and (b) of FIG. 17.

In part (a) of FIG. 17, the toner cartridge 70k is mounted to the tray 80k, and the swing arm 100k is positioned in the first position. In part (b) of FIG. 17, the toner cartridge 70k is demounted from the tray 80k, and the swing arm 100k is swung toward the second position.

At this time, a center of gravity of the swing arm 100k is illustrated as a center of gravity G2.

As shown in part (a) of FIG. 17, in a state in which the swing arm 100k is positioned in the first position, on the swing arm 100k, moment N1, moment N2, and moment N3 act around the swing shaft 101k. The moment N1 is moment by a self-weight of the swing arm 100k with the swing shaft 101k as a center, and the moment N2 is moment acting on the swing arm 100k by pressing of the portion-to-be-pressed 103k of the swing arm 100k by the toner cartridge 70k. Further, the moment N3 is moment received from the urging member 110k by the swing arm 100k.

The center of gravity G2 of the swing arm 100k is positioned on a side opposite from the portion-to-be-pressed 103k while sandwiching the swing shaft 101k therebetween, and therefore, the moments N1 and N2, and the moment N3 are directed opposite to each other. The center of gravity G2 of the swing arm 100k is positioned so that the swing arm 100k is urged from the first position toward the second position by the self-weight thereof. Further, the moment N3 by the urging member 110k as a first urging member also acts so as to urge the swing arm 100k from the first position toward the second position. That is, a sum of the moment N1 about the swing shaft 101k by the shaft of the swing arm 100k and the moment N3 about the swing shaft 101k by the urging force of the urging member 110k act so as to rotate the swing arm 100k from the first position toward the second position. Further, the moment N2 and the sum of the moment N1 and the moment N3 balance each other, so that the swing arm 100k is held in the first position without being swung from the first position to the second position.

Incidentally, the center of gravity G2 of the swing arm 100m is positioned so that the swing arm 100m is urged from the third position toward the fourth position by a self-weight thereof. Further, the moment N3 by the urging member 110m as a first urging member also acts so as to urge the swing arm 100m from the third position toward the fourth position. That is, a sum of the moment N1 about the swing shaft 101m by the shaft of the swing arm 100m and the moment N3 about the swing shaft 101m by the urging force of the urging member 110m act so as to rotate the swing arm 100m from the third position toward the fourth position.

As shown in part (b) of FIG. 17, when the toner cartridge 70k is demounted from the tray 80k, on the swing arm 100k, the moment N1 by the self-weight of the swing arm 100k and the moment N3 by the urging member 110k act around the swing shaft 101k. By this, the swing arm 100k is swung from the first position toward the second position. When the portion-to-be-pressed 103k of the swing arm 100k abuts against the stopper portion 104k of the tray 80k, the sum of the moments N1 and N3, and moment due to that the stopper portion 104k presses the portion-to-be-pressed 103k balance each other, so that the swing arm 100k is held in the second position.

By the constitution as described above, also as regards the embodiment 2, an effect similar to the effect of the embodiment 1 can be achieved. Further, even when the center of gravity G2 of the swing arm 100k is positioned close to the swing shaft 101k, by the urging force of the urging member 110k, the swing arm 100k can be urged from the first position toward the second position. For this reason, a degree of freedom in design can be improved.

### Modified Embodiment of Embodiment 2

Next, a modified embodiment of the embodiment 2 will be described using parts (a) and (b) of FIG. 18. In the modified embodiment of the embodiment 2, compared with the embodiment 2, only the position of the center of gravity G of the swing arm 100k is changed. For this reason, constitutions similar to those in the embodiment 2 will be omitted from illustration or will be described by adding the same reference numerals or symbols to the drawings. Parts (a) and (b) of FIG. 18 are sectional views showing an operation of the swing arm 100k.

In part (a) of FIG. 18, the toner cartridge 70k is mounted to the tray 80k, and the swing arm 100k is positioned in the first position. In part (b) of FIG. 18, the toner cartridge 70k is demounted from the tray 80k, and the swing arm 100k is swung toward the second position.

At this time, a center of gravity of the swing arm 100k is illustrated as a center of gravity G3.

As shown in part (a) of FIG. 18, in a state in which the swing arm 100k is positioned in the first position, on the swing arm 100k, moment N2, moment N3, and moment N4 act around the swing shaft 101k. The moment N4 is moment by a self-weight of the swing arm 100k with the swing shaft 101k as a center, and the moment N2 is moment acting on the swing arm 100k by pressing of the portion-to-be-pressed 103k of the swing arm 100k by the toner cartridge 70k. Further, the moment N3 is moment received from the urging member 110k by the swing arm 100k.

The center of gravity G3 of the swing arm 100k is positioned on the same side as the portion-to-be-pressed 103k while sandwiching the swing shaft 101k therebetween, and therefore, the moment N3, and the moments N2 and N4 are directed opposite to each other. The center of gravity G3 of the swing arm 100k is positioned so that the swing arm 100k is urged from the second position toward the first position by the self-weight thereof. On the other hand, the moment N3 by the urging member 110k acts so as to urge the swing arm 100k from the first position toward the second position. Further, in this embodiment, a sum of the moment N4 about the swing shaft 101k by the shaft of the swing arm 100k and the moment N3 about the swing shaft 101k by the urging force of the urging member 110k act so as to rotate the swing arm 100k from the first position toward the second position. That is, the moment N3 is larger than the moment N4. Further, the sum of the moment N2 and the moment N4 and the moment N3 balance each other, so that the swing arm 100k is held in the first position without being swung from the first position to the second position.

Incidentally, the center of gravity G3 of the swing arm 100m is positioned so that the swing arm 100m is urged from the fourth position toward the third position by a self-weight thereof. Further, the moment N3 by the urging member 110m acts so as to urge the swing arm 100m from the third position toward the fourth position. Further, a sum of the moment N4 about the swing shaft 101m by the shaft of the swing arm 100m and the moment N3 about the swing shaft 101m by the urging force of the urging member 110m act so as to rotate the swing arm 100m from the third position toward the fourth position.

By the constitution as described above, also as regards the modified embodiment of the embodiment 2, an effect similar to the effect of the embodiment 1 can be achieved. Further, even when the center of gravity G3 of the swing arm 100k is positioned on the same side as the portion-to-be-pressed 103k with respect to the swing shaft 101k, by the urging force of the urging member 110k, the swing arm 100k can be urged from the first position toward the second position. For this reason, a degree of freedom in design can be improved.

### OTHER EMBODIMENTS

Incidentally, in the above-described embodiments 1 and 2, the swing arm 100k was provided only in an upstream end portion of the tray 80k with respect to the Y direction, but the present invention is not limited thereto. For example, the swing arm 100k may be provided only in a downstream end portion of the tray 80k with respect to the Y direction or may be provided in each of the upstream end portion and the downstream end portion of the tray 80k with respect to the Y direction.

Further, in the above-described embodiments 1 and 2, the swing arm 100k was constituted so as to be swingable about the swing shaft 101k, but the present invention is not limited thereto. For example, instead of the swing arm 100k, a slide member capable of being slidable and movable is provided, and the slide member may have a function similar to the function of the swing arm 100k. At this time, a sliding direction of the slide member may only be required not to be parallel to the X direction, and may be the Y direction or the Z direction, for example.

Further, in the above-described embodiments 1 and 2, the swing arm 100k was constituted so as to abut against the frame 16 when the tray 80k is moved from the taking-out position to the accommodating position in a state in which the swing arm 100k is positioned in the second position, but the present invention is not limited thereto. That is, the swing arm 100k does not have to abut against an outside surface of the frame 16 when the swing arm 100k is capable of restricting the movement of the tray 80k from the taking-out position to the accommodating position in the state in which the swing arm 100k is positioned in the second position. For example, the swing arm 100k may abut against an inside stopper of the frame 16 in the state in which the swing arm 100k is positioned in the second position.

Further, in the above-described embodiments 1 and 2, the constitution in which the rotary main body 90 is provided with the four developing units 50y to 50k and in which the color image is capable of being formed with the tray of the four colors was described. However, the rotary main body 90 may also be provided with three or less developing units or five or more developing units. In these cases, correspondingly to the number of the developing units, the number and arrangement of the trays and the toner cartridges can be appropriately changed. For example, in the above-described embodiments 1 and 2, a constitution in which the four toner cartridges 70y to 70k are detachably mountable to the rotary main body 90 was described. However, a constitution in which the rotary main body 90 includes only one developing unit 50k and in which only one toner cartridge 70k is mounted to the rotary main body 90 may be employed. In this case, the rotary main body 90 is capable of taking the black exchange attitude and the black development attitude alternately by being rotated about the rotational axis 90C clockwise in FIG. 1.

Further, in the above-described embodiments 1 and, the constitution in which the rotary main body 90 is provided with the four developing units 50y to 50k and in which the color image is capable of being formed with the tray of the four colors was described. However, the rotary main body 90 may include a plurality of developing units capable of executing image formation by using tray of the same color. For example, a constitution in which the rotary main body 90 includes four developing units 50k for black and in which four toner cartridges 70k are mounted to the rotary main body 90 may be employed.

According to the present invention, it is possible to suppress forgetting of mounting of a cartridge to a tray.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075333 filed on May 7, 2024, which is hereby incorporated by reference herein in its entirety.

What is claimed is:

1. An image forming apparatus to which a first toner cartridge is detachably mounted, comprising:
a rotatable rotary including a first developing roller and a first accommodating frame including a first accommodating portion for accommodating toner supplied to the first developing roller;
a main assembly frame provided with an opening and configured to accommodate the rotary;
a first supporting member configured to support the first toner cartridge and movable from a first taking-out position to a first accommodating position in a first movement direction through the opening, wherein in a state in which the first supporting member is in the first accommodating position, the first toner cartridge is in a first mounting position relative to the first accommodating frame, where supply of the toner from the first toner cartridge to the first accommodating frame is permitted, and in a state in which the first supporting member is in the first taking-out position, the first toner cartridge is in a first retracted position where the first toner cartridge is detachably mountable to the first supporting member; and
a first moving member mounted to the first supporting member, the first moving member being positioned in a first position when the first toner cartridge is mounted to the first supporting member and being positioned in a second position when the first toner cartridge is demounted from the first supporting member,
wherein in the state in which the first supporting member is in the first taking-out position, as viewed in the first movement direction, a whole of the first moving member in the first position is positioned inside the opening and at least a part of the first moving member in the second position projects to an outside of the opening.

2. An image forming apparatus according to claim 1, wherein when the first moving member is positioned in the first position, movement of the first supporting member from the first taking-out position to the first accommodating position is permitted, and when the first moving member is positioned in the second position, the movement of the first supporting member from the first taking-out position to the first accommodating position is restricted by abutment of the first moving member against the main assembly frame.

3. An image forming apparatus according to claim 1, wherein the first moving member is provided on a side downstream of a center of the first supporting member with respect to the first movement direction.

4. An image forming apparatus according to claim 1, wherein a center of gravity of the first moving member is positioned so that the first moving member is urged from the first position toward the second position by a self-weight thereof.

5. An image forming apparatus according to claim 1, further comprising an urging member configured to urge the first moving member from the first position toward the second position.

6. An image forming apparatus according to claim 1, wherein the first moving member is rotatable about a rotation shaft between the first position and the second position.

7. An image forming apparatus according to claim 6, further comprising an urging member configured to urge the first moving member,
wherein a sum of a moment about the rotation shaft by a self-weight of the first moving member and a moment about the rotation shaft by an urging force of the urging member acts so as to rotate the first moving member from the first position toward the second position.

8. An image forming apparatus according to claim 1, wherein a second toner cartridge is detachably mounted to the image forming apparatus,
wherein the rotatable rotary includes a second developing roller and a second accommodating frame including a second accommodating portion for accommodating toner supplied to the second developing roller,
wherein the image forming apparatus further comprises:
a second supporting member configured to support the second toner cartridge and movable from a second taking-out position to a second accommodating portion in a second movement direction through the opening, wherein in a state in which the second supporting member is in the second accommodating position, the second toner cartridge is in a second mounting position relative to the second accommodating frame, where supply of the toner from the second toner cartridge to the second accommodating frame is permitted, and in a state in which the second supporting member is in the second taking-out position, the second toner cartridge is in a second retracted position where the second toner cartridge is detachably mountable to the second supporting member; and
a second moving member mounted to the second supporting member, the second moving member being positioned in a third position when the second toner cartridge is mounted to the second supporting member and being positioned in a fourth position when the second toner cartridge is demounted from the second supporting member,
wherein in the state in which the second supporting member is in the second taking-out position, as viewed in the second movement direction, a whole of the second moving member in the second position is positioned inside the opening and at least a part of the second moving member in the fourth position projects to an outside of the opening.

9. An image forming apparatus to which a first toner cartridge is detachably mounted, comprising:
a rotatable rotary including a first developing roller and a first accommodating frame including a first accommodating portion for accommodating toner supplied to the first developing roller;
a main assembly frame configured to accommodate the rotary;
a first supporting member configured to support the first toner cartridge and movable from a first taking-out position to a first accommodating position, wherein in a state in which the first supporting member is in the first accommodating position, the first toner cartridge is in a first mounting position relative to the first accommodating frame, where supply of the toner from the first toner cartridge to the first accommodating frame is permitted, and in a state in which the first supporting member is in the first taking-out position, the first toner cartridge is in a first retracted position where the first toner cartridge is detachably mountable to the first supporting member; and
a first moving member mounted to the first supporting member, the first moving member being positioned in a first position when the first toner cartridge is mounted to the first supporting member and being positioned in a second position when the first toner cartridge is demounted from the first supporting member,
wherein in when the first moving member is positioned in the first position, movement of the first supporting member from the first taking-out position to the first accommodating position is permitted, and when the first moving member is positioned in the second position, the movement of the first supporting member from the first taking-out position to the first accommodating position is restricted.

10. An image forming apparatus according to claim 9, wherein a second toner cartridge is detachably mounted to the image forming apparatus,
wherein the rotatable rotary includes a second developing roller and a second accommodating frame including a second accommodating portion for accommodating toner supplied to the second developing roller,
wherein the image forming apparatus further comprises:
a second supporting member configured to support the second toner cartridge and movable from a second taking-out position to a second accommodating portion, wherein in a state in which the second supporting member is in the second accommodating position, the second toner cartridge is in a second mounting position relative to the second accommodating frame, where supply of the toner from the second toner cartridge to the second accommodating frame is permitted, and in a state in which the second supporting member is in the second taking-out position, the second toner cartridge is in a second retracted position where the second toner cartridge is detachably mountable to the second supporting member; and
a second moving member mounted to the second supporting member, the second moving member being positioned in a third position when the second toner cartridge is mounted to the second supporting member and being positioned in a fourth position when the second toner cartridge is demounted from the second supporting member,
wherein when the second moving member is positioned in the third position, movement of the second supporting member from the second taking-out position to the second accommodating position is permitted, and when the second moving member is positioned in the fourth position, the movement of the second supporting member from the second taking-out position to the second accommodating position is restricted.
